(19) United States
(12) Patent Application Publication
(10) Pub. No.: US 2005/0195722 A1
(43) Pub. Date: Sep. 8, 2005

(54) Reproducing apparatus, recording and reproducing apparatus and reproducing method

(76) Inventors: Takayuki Tsukamoto, Kawasaki-shi (JP); Kazuki Matsumoto, Kawasaki-shi (JP); Rumiko Hayase, Yokohama-shi (JP); Akiko Hirao, Chiba-shi (JP); Katsutaro Ichihara, Yokohama-shi (JP); Urara Ichihara, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/065,075

(22) Filed: Feb. 25, 2005

(30) Foreign Application Priority Data
Feb. 25, 2004 (JP) 2004-049750

(51) Int. Cl. G11B 7/00

(52) U.S. Cl. 369/103

(57) ABSTRACT

Provided is a technique for reproducing information recorded on a holographic recording medium including a reflecting layer and a recording layer. When reproducing, a reproducing reference light is focused on a reflecting surface of the reflecting layer to produce a phase conjugate reproduced light and an ordinary reproduced light, and the phase conjugate reproduced light and the ordinary reproduced light are guided to a sensing surface of an image sensor to produce on the sensing surface a first reproduced image and a second reproduced image smaller than the first reproduced image, respectively. An intensity of the ordinary reproduced light on the sensing surface is higher than an intensity of the phase conjugate reproduced light on the sensing surface. An output of the image sensor corresponding to a non-overlapping portion of the first reproduced image which does not overlap the second reproduced image is utilized for reproducing the information.

### CROSS-REFERENCE TO RELATED APPLICATIONS

This application is based upon and claims the benefit of priority from prior Japanese Patent Application No. 2004-049750, filed Feb. 25, 2004, the entire contents of which are incorporated herein by reference.

### BACKGROUND OF THE INVENTION

1. Field of the Invention

The present invention relates to a reproducing apparatus, a recording and reproducing apparatus and a reproducing method, and more particularly to a reproducing apparatus, a recording and reproducing apparatus and a reproducing method which reproduce information recorded on a reflection type holographic recording medium.

2. Description of the Related Art

In a field of data recording, as a recording mode which can realize an inexpensive mass storage file, an optical recording mode has been studied. In a general optical recording mode, information of one bit is assigned to one recording mark, and respective recording marks are arranged away from one another.

In such a mode, the recording density can be increased by reducing a size of the recording mark by using, e.g., a recording light with a short wavelength. However, improvement in recording density by such a technique has reached its limit, and a further increase in capacity is difficult.

In a holographic recording mode, information can be three-dimensionally recorded, unlike other optical recording modes. Further, in the holographic recording mode, as a material of a recording layer, used is the one whose optical properties continuously vary in accordance with an exposure quantity. Therefore, information of two or more bits can be assigned to one recording mark, and/or a plurality of recording marks can be partially superimposed on one another. Therefore, the holographic recording mode is expected as an optical recording mode which realizes a further increase in capacity.

Jpn. Pat. Appln. KOKAI Publication No. 11-311938 discloses a recording and reproducing apparatus which has a reflection type holographic recording medium mounted therein. In the recording and reproducing apparatus, a recording optical system and a reproducing optical system are arranged on the same side of the recording medium, and they share many portions. Therefore, the recording and reproducing apparatus has advantages in reduction in size, and alignment of the optical systems is relatively easy.

Meanwhile, in the recording and reproducing apparatus having a reflection type holographic recording medium mounted therein, two types of images which are symmetrical with respect to a point are reproduced. These reproduced images overlap each other on a sensing surface of a reproducing image sensor. Therefore, when sensing one reproduced image, the other reproduced image acts as noise as long as these reproduced images are not equal to each other. In the recording and reproducing apparatus having the reflection type holographic recording medium mounted therein, therefore, a high signal-to-noise ratio, i.e. S/N, is difficult to be realized in reproduction.

### BRIEF SUMMARY OF THE INVENTION

According to a first aspect of the present invention, there is provided a reproducing apparatus which reproduces information recorded on a holographic recording medium comprising a reflecting layer with a reflecting surface and a recording layer facing the reflecting surface, comprising a light source which emits a light, an image sensor with a sensing surface, an optical system which focuses the light emitted from the light source as a reproducing reference light on the reflecting surface to produce a phase conjugate reproduced light and an ordinary reproduced light and guides the phase conjugate reproduced light and the ordinary reproduced light from the recording medium to the sensing surface to produce first and second images on the sensing surface, the first image corresponding to the phase conjugate reproduced light and the second image corresponding to the ordinary reproduced light, wherein the second image is smaller than the first image, and wherein an intensity of the ordinary reproduced light on the sensing surface is higher than an intensity of the phase conjugate reproduced light on the sensing surface, and an information reproduction processor which processes an output of the image sensor corresponding to a non-overlapping portion to reproduce the information, the non-overlapping portion being a portion of the first image which does not overlap the second image.

According to a second aspect of the present invention, there is provided a recording and reproducing apparatus which records information on a holographic recording medium and reproduces the information recorded on the recording medium, the recording medium comprising a reflecting layer with a reflecting surface and a recording layer facing the reflecting surface, comprising a light source which emits a light, an image sensor with a sensing surface, an optical system which executes a first optical operation when information is recorded and executes a second optical operation when the information is reproduced, wherein the first optical operation includes focusing a part of the light emitted from the light source as a recording reference light on the reflecting surface, producing an information light by generating a two dimensional distribution of optical property which corresponds to the information to be recorded in another part of the light emitted from the light source, and focusing the information light on a position spaced apart from the reflecting layer on the recording layer's side of the reflecting layer, and wherein the second optical operation includes focusing a part of the light emitted from the light source as a reproducing reference light on the reflecting surface to produce a phase conjugate reproduced light and an ordinary reproduced light and guiding the phase conjugate reproduced light and the ordinary reproduced light from the recording medium to the sensing surface to produce first and second images on the sensing surface, the first image corresponding to the phase conjugate reproduced light and the second image corresponding to the ordinary reproduced light, the second image being smaller than the first image, and an intensity of the ordinary reproduced light on the sensing surface being higher than an intensity of the phase conjugate reproduced light on the sensing surface, and an information reproduction processor which processes an output of the image sensor corresponding to a non-overlapping portion to reproduce the information, the non-overlapping portion being a portion of the first image which does not overlap the second image.

According to a third aspect of the present invention, there is provided a method of reproducing information recorded on a holographic recording medium comprising a reflecting layer with a reflecting surface and a recording layer facing the reflecting layer, the information being recorded by a simultaneous irradiation of a recording reference light focused on the reflecting surface and an information light focused on a position spaced apart from the reflecting layer on the recording layer's side of the reflecting layer, comprising focusing a light emitted from a light source as a reproducing reference light on the reflecting surface to produce a phase conjugate reproduced light and an ordinary reproduced light and guiding the phase conjugate reproduced light and the ordinary reproduced light from the recording medium to a sensing surface of an image sensor to produce first and second images on the sensing surface, the first image corresponding to the phase conjugate reproduced light and the second image corresponding to the ordinary reproduced light, wherein the second image is smaller than the first image, and wherein an intensity of the ordinary reproduced light on the sensing surface is higher than an intensity of the phase conjugate reproduced light on the sensing surface, and processing an output of the image sensor corresponding to a non-overlapping portion to reproduce the information, the non-overlapping portion being a portion of the first image which does not overlap the second image.

### BRIEF DESCRIPTION OF THE SEVERAL VIEWS OF THE DRAWING

FIG. 1 is a view schematically showing a recording and reproducing apparatus according to a first embodiment of the present invention;

FIG. 2 is a plane view schematically showing an example of a split retardation element;

FIG. 3 is a cross-sectional view schematically showing an example of a holographic recording medium which can be mounted in the recording and reproducing apparatus depicted in FIG. 1;

FIG. 4 is a plane view schematically showing an example of a structure which can be employed in the holographic recording medium illustrated in FIG. 3;

FIG. 5 is a cross-sectional view schematically showing a light path of a reference light;

FIG. 6 is a cross-sectional view schematically showing a light path of an information light;

FIGS. 7 to 10 are views schematically showing a relationship between a reproduced light and an optical property distribution formed in a recording layer by the information light which has entered a right portion of the split retardation element;

FIG. 11 is a plane view schematically showing an example of an image sensor which can be used in the recording and reproducing apparatus depicted in FIG. 1;

FIG. 12 is a plane view schematically showing another example of the image sensor which can be used in the recording and reproducing apparatus depicted in FIG. 1;

FIG. 13 is a graph showing an example of an output from a timing signal detecting photodetector included in the image sensor depicted in FIG. 12;

FIG. 14 is a plane view schematically showing still another example of the image sensor which can be used in the recording and reproducing apparatus depicted in FIG. 1;

FIG. 15 is a graph showing an example of an output difference between first and second detecting portions of a timing signal detecting photodetector included in the image sensor depicted in FIG. 14;

FIG. 16 is a plane view schematically showing yet another example of the image sensor which can be used in the recording and reproducing apparatus depicted in FIG. 1;

FIG. 17 is a graph showing an example of an output difference between first and second detecting portions of a timing signal detecting photodetector included in the image sensor depicted in FIG. 16;

FIG. 18 is a plane view schematically showing a further example of the image sensor which can be used in the recording and reproducing apparatus depicted in FIG. 1;

FIG. 19 is a graph showing an example of a sum of outputs from second pixels;

FIG. 20 is a plane view schematically showing an example of a reproduced image which a phase conjugate reproduced light forms on a sensing surface of the image sensor;

FIG. 21 is a plane view schematically showing a still further example of the image sensor which can be used in the recording and reproducing apparatus depicted in FIG. 1;

FIG. 22 is a graph showing a ratio of an average beam diameter, which is an average of a beam diameter of an information light as a direct light and a beam diameter of an information light as a reflected light, at a position of an objective lens with respect to a beam diameter of linearly polarized light immediately after exiting a polarizing beam splitter;

FIG. 23 is a graph showing an optical length from a reflecting layer to a position where the information light is focused;

FIG. 24 is a graph showing an absolute value of a common logarithm of a beam diameter ratio, which is a ratio of a beam diameter of an information light as a direct light and a beam diameter of an information light as a reflected light, at a position of the objective lens;

FIG. 25 is a graph showing an example of a relationship between a distance from a surface of the reflecting layer and a light intensity;

FIG. 26 is a graph showing another example of the relationship between the distance from the surface of the reflecting layer and the light intensity;

FIG. 27 is a graph schematically showing a recording and reproducing apparatus according to a second embodiment of the present invention;

FIG. 28 is a view schematically showing a recording and reproducing apparatus according to a third embodiment of the present invention;

FIG. 29 is a view schematically showing a recording and reproducing apparatus according to a fourth embodiment of the present invention;

FIG. 30 is a view schematically showing a recording and reproducing apparatus according to a comparative example; and

FIG. 31 is a view schematically showing a recording and reproducing apparatus according to Example 2 of the present invention.

### DETAILED DESCRIPTION OF THE INVENTION

Embodiments of the present invention will now be described hereinafter with reference to the accompanying drawings. The same reference numerals denote the same or similar constituent elements throughout the drawings, and a repetitive description thereof will be omitted.

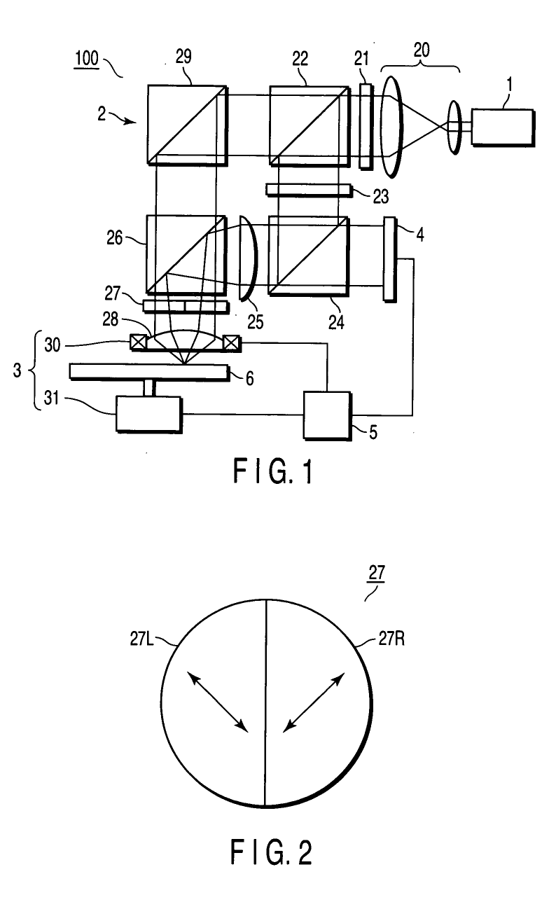

FIG. 1 is a view schematically showing a recording and reproducing apparatus according to a first embodiment.

The recording and reproducing apparatus 100 includes a light source 1, an optical system 2, a drive mechanism 3, an image sensor 4 and an information processor 5. The recording and reproducing apparatus 100 has a reflection type holographic recording medium 6 detachably mounted therein.

The light source 1 emits lights which can be utilized as an information light, a recording reference light and a reproducing reference light. As the light source 1, it is desirable to use a laser which emits coherent linearly polarized light. As the laser, it is possible to use, e.g., a semiconductor laser, an He-Ne laser, an argon laser, a YAG laser and the like.

When recording, the optical system 2 guides a part of the light emitted from the light source 1 to the recording medium 6 as the recording reference light, and guides another part of the light emitted from the light source 1 to the recording medium 6 as the information light. The recording reference light typically has a substantially homogenous optical property distribution. The recording reference light is focused on a reflecting layer surface of the recording medium 6. In contrast, a two-dimensional distribution of optical properties is given to the information light in accordance with information to be recorded. The information light irradiates the recording medium 6 coaxially with the recording reference light, and is focused on a position which is on the front side apart from the reflecting layer surface of the recording medium 6.

When reproducing, the optical system 2 guides a part of the light emitted from the light source 1 to the recording medium 6 as the reproducing reference light, and guides a phase conjugate reproduced light and an ordinary reproduced light, which the recording medium 6 outputs, to the image sensor 4. The reproducing reference light typically has a substantially homogenous optical property distribution. The reproducing reference light is focused on the reflecting layer surface of the recording medium 6 like the recording reference light.

The phase conjugate reproduced light is a light which travels along the same light path as that of the information light in a direction opposite to that of the information light. The phase conjugate reproduced light has a two-dimensional distribution of optical properties according to information recorded in the recording layer, and forms a first reproduced image on a sensing surface of the image sensor 4. In contrast, the ordinary reproduced light is a light which travels along the same light path as that of the information light in the same direction as that of the information light. The ordinary reproduced light has a two-dimensional distribution of optical properties according to information recorded on the recording layer, and forms a second reproduced image on the sensing surface of the image sensor 4. The first and second reproduced images are symmetrical with respect to a center of the first reproduced image. It is to be noted that the first reproduced image has a larger size and a weaker light intensity than the second reproduced image.

In this embodiment, the optical system 2 includes a beam expander 20, a retardation element 21, a polarizing beam splitter 22, a transmission type spatial light modulator 23, a beam splitter 24, a converging lens 25, a polarizing beam splitter 26, a split retardation element 27, an objective lens 28 and a beam splitter 29.

The beam expander 20 increases a beam diameter of a light beam emitted from the light source 1, and sends out the light beam as collimated beam.

The retardation element 21 rotates a polarization plane of the light beam or converts the light beam into circularly polarized light or elliptically polarized light to give off P-polarized light component and an S-polarized light component whose electric-field vectors oscillate in directions perpendicular to each other. As the retardation element 13, it is possible to use, e.g., a λ/2 retardation plate or a λ/4 retardation plate.

The polarizing beam splitter 22 reflects the S-polarized light component and transmits therethrough the P-polarized light component of the light beams exiting from the retardation element 21. The P-polarized light component is utilized as a recording reference light or a reproducing reference light.

The transmission type spatial light modulator 23 includes many pixels arranged in a matrix form like a transmission type liquid crystal display, and can switch the transmitted light between the P-polarized light component and the S-polarized light component for each pixel. In this manner, the transmission type spatial light modulator 23 outputs an information light having a two-dimensional polarization distribution given thereto in accordance with information to be recorded. When reproducing, the transmission type spatial light modulator 23 is driven so that all the pixels output the P-polarized light components. It is to be noted that the transmission type spatial light modulator 23 is used as a spatial light modulator in this embodiment, a reflection type spatial light modulator such as a digital mirror array can be used in place of the transmission type spatial light modulator 23.

The beam splitter 24 reflects a part of the information light toward the converging lens 25. Furthermore, the beam splitter 24 transmits a part of the phase conjugate reproduced light and a part of the ordinary reproduced light therethrough and gives off them toward the image sensor 4.

The converging lens 25 converges the information light to convert the information light as collimated light into convergent light. The converging lens 25 is arranged on a light path of the information light away from light paths of the recording reference light and the reproducing reference light. Here, the converging lens 25 is arranged on the light paths of the information light, the phase conjugate reproduced light and the ordinary reproduced light away from the light paths of the recording reference light and the reproducing reference light.

The polarizing beam splitter 26 reflects the S-polarized light component and transmits the P-polarized light component therethrough. That is, when recording, the polarizing beam splitter 26 reflects toward the split retardation element 27 only the S-polarized light component of the information light which has entered the polarizing beam splitter 26 as convergent light, and transmits the recording reference light, which has entered as collimated light, toward the split retardation element 27. When reproducing, the polarizing beam splitter 26 transmits the reproducing reference light, which has entered as collimated light, toward the split retardation element 27 without reflecting toward the split retardation element 27 all of the lights which has entered through the transmission type spatial light modulator 23 and the converging lens 25 into the polarizing beam splitter 26.

The split retardation element 27 includes right and left portions differing in optical properties from each other. For example, the S-polarized light component which has entered the right portion of the split retardation element 27 is converted into right-handed circularly polarized light, and the S-polarized light component which has entered the left portion is converted into left-handed circularly polarized light. In this case, it is possible to use, e.g., a λ/4 retardation plate for each portion of the split retardation element 27.

FIG. 2 is a plane view schematically showing an example of the split retardation element 27. The split retardation element 27 includes a left portion 27L and a right portion 27R each of which has a semicircular shape. Each of the left portion 27L and the right portion 27R is a λ/4 retardation plate, and optic axes of the left portion 27L and the right portion 27R indicated by double arrows in the drawing form an angle of 90°. Additionally, the optic axes of the left portion 27L and the right portion 27R typically form an angle of ±45° with respect to their boundary. The split retardation element 27 is arranged such that the optic axes of the left portion 27L and the right portion 27R form an angle of ±45 ° with respect to polarization planes of the P-polarized light component and the S-polarized light component which the polarizing beam splitter 26 gives off.

The objective lens 28 gives off as convergent lights the recording reference light or the reproducing reference light which has entered as collimated light and the information light which has entered as convergent light.

The beam splitter 29 reflects a part of the recording reference light and a part of the reproducing reference light toward the polarizing beam splitter 26.

The drive mechanism 3 relatively moves the objective lens 28 and the recording medium 6. Specifically, the drive mechanism 3 relatively moves the objective lens 28 and the recording medium 6 in a first direction along a recording track of the recording medium 6, a second direction which is parallel to a main surface of the recording medium 6 and crosses the first direction, and a third direction which crosses the main surface of the recording medium 6 and is typically substantially vertical to the main surface of the recording medium 6. In this embodiment, the drive mechanism 3 includes a motor 31 and an actuator 30. A spindle of the motor 31 rotatably and detachably supports the recording medium 6. Further, the actuator 30 is, e.g., a piezoelectric actuator, and moves the objective lens 28 in a horizontal direction and a vertical direction in the drawing.

The image sensor 4 is an area image sensor which reads a reproduction signal, and has a plurality of pixels arranged in a row direction and a column direction on a sensing surface thereof. The image sensor 4 detects a light intensity for each pixel. When reproducing, a first reproduced image corresponding to the phase conjugate reproduced light and a second reproduced image corresponding to the ordinary reproduced light and having a smaller size and a stronger light intensity than the first reproduced image are formed on the sensing surface of the image sensor 4.

The information processor 5 serves as an information reproduction processor which reproduces information from an output of the image sensor 4 corresponding to a non-overlapping portion of the first reproduced image, i.e., a portion of the first reproduced image which does not overlap the second reproduced image. For example, differences in size and in light intensity between the first reproduced image and the second reproduced image can be utilized in order to specify the non-overlapping portion.

The information processor 5 separates a first reproduced image corresponding to a recording mark from the first reproduced images corresponding to other recording marks based on an output from the image sensor 4 corresponding to the second reproduced image. The second reproduced image has a smaller size and a stronger light intensity than the first reproduced image. Therefore, the second reproduced image corresponding to a given recording mark can be readily separated from the second reproduced images corresponding to recording marks adjacent to the former recording mark in a track direction. Moreover, a relative position of the first reproduced image with respect to the second reproduced image is fixed. Therefore, the first reproduced image corresponding to a given recording mark can be separated from the first reproduced images corresponding to other recording marks based on an output from the image sensor 4 corresponding to the second reproduced image.

The information processor 5 controls an operation of the drive mechanism 3 based on an output from the image sensor 4 corresponding to the second reproduced image. For example, the information processor 5 controls a relative velocity of the objective lens 28 with respect to the recording medium 6 in the first direction along the recording track or a relative position of the objective lens 28 with respect to the recording medium 6 in the second direction crossing the first direction based on an output from the image sensor 4 corresponding to the second reproduced image.

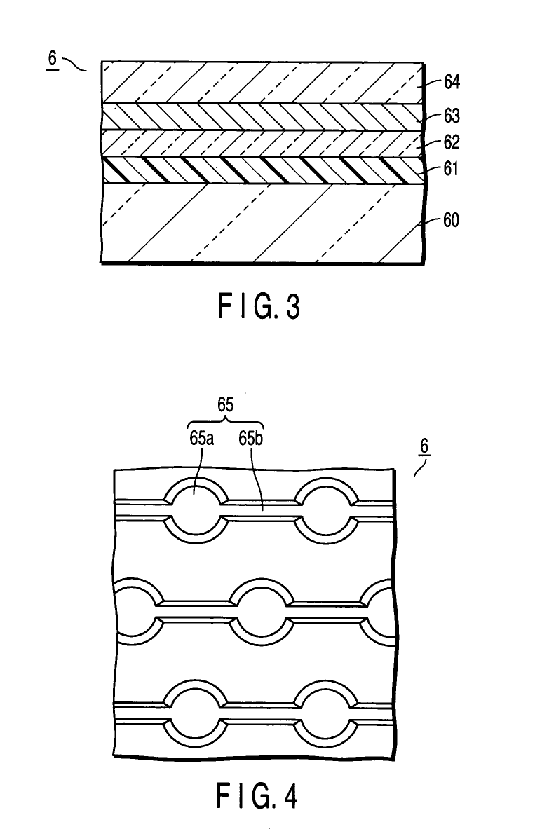

FIG. 3 is a cross-sectional view schematically showing an example of a holographic recording medium which can be mounted in the recording and reproducing apparatus 100 depicted in FIG. 1.

The holographic recording medium 6 includes a cover sheet 60, a recording layer 61, a first protecting layer (transparent substrate) 62, a reflecting layer 63, and a second protecting layer 64. Although the holographic recording medium 6 is not restricted to a specific shape, it typically has a disk-like or card-like shape. A plurality of address/servo areas each having a band-like shape can be formed in a radial pattern as positioning areas on an interface between the first protecting layer 62 and the reflecting layer 63. Information required to perform focus servo and tracking servo by a sampled servo method and address information are recorded in these address/servo areas in advance by using embossed pits or the like. Each data area which is sandwiched between the address/servo areas may have, e.g., a flat surface, or be provided with grooves shown in FIG. 4.

FIG. 4 is a plane view schematically showing an example of a structure which can be employed in the holographic recording medium 6 depicted in FIG. 3. In FIG. 4, the data area is illustrated. In the data area, provided are grooves 65 each having a shape in which a substantially circular recessed portion 65a and a groove portion 65b whose width is narrower than a diameter of the recessed portion 65 a are alternately connected. If the recording medium 6 has a disk-like shape, the grooves 65 usually has a spiral shape or a concentric circular shape.

In the recording medium 6 depicted in FIGS. 3 and 4, as the cover sheet 60, a transparent substrate made of a transparent material such as polycarbonate or polymethyl methacrylate (PMMA) can be used.

The recording layer 61 contains a hologram material whose optical properties such as a refractive index or a transmittance vary depending on an intensity of the irradiation light. Examples of the hologram material include HRF-700 which is photopolymer manufactured by Dupont. A thickness of the recording layer 61 can be, e.g., 100 μm or thicker in order to obtain sufficient M/#. The definition of M/# will be described later.

The first protecting layer (transparent substrate) 62 serves as a spacer which arranges the recording layer 61 away from the reflecting layer 63. As a material of the first protecting layer 62, it is possible to use transparent plastic such as polycarbonate or PMMA, glass, a transparent dielectric material such as ZnS, SiO₂ or a mixture of these substances, and a transparent material of a laminated structure made of these substances. A thickness of the first protecting layer 62 can be, e.g., 100 μm or thicker.

As a material of the reflecting layer 63, it is possible to use, e.g., a metal such as Al or Ag, or an alloy containing these substances. The reflecting layer 63 can have a thickness with which the recording light is not transmitted therethrough, e.g., 50 μm or thicker.

As a material of the second protecting layer 64, it is possible to utilize, e.g., a dielectric material such as ZnS, SiO₂ or a mixture of these substances, transparent plastic such as polycarbonate or PMMA, glass and the like. The second protecting layer 64 does not have to be provided. When a substrate which can be solely handled is used as the second protecting layer 64, an adhesive layer containing, e.g., ultraviolet curing resin may be interposed between the second protecting layer 64 and the reflecting layer 63.

When the second protecting layer 64 is not provided, the holographic recording medium 6 can be manufactured by the following method. For example, the recording layer 61, the first protecting layer 62 and the reflecting layer 63 are sequentially formed on the cover sheet 60. Alternatively, the first protecting layer 62 with the reflecting layer 63 on a surface thereof and the cover sheet 60 with the recording layer on a surface thereof are attached to each other such that the recording layer 61 faces the first protecting layer 62. Alternatively, a multilayered structure of the recording layer 61, the first protecting layer 62 and the reflecting layer 63 is attached to the cover sheet 60 such that the recording layer 61 faces the cover sheet 60.

When the second protecting layer 64 is provided, the holographic recording medium 6 can be manufactured by the following method. For example, the reflecting layer 63 is covered with the second protecting layer 64 at any of the above-described stages. Alternatively, a multilayered structure of the first protecting layer 62, the reflecting layer 63 and the second protecting layer 64 is attached to the cover sheet 60 with the recording layer 61 thereon such that the first protecting layer 62 faces the recording layer 61. Alternatively, a multilayered structure of the recording layer 61, the first protecting layer 62, the reflecting layer 63 and the second protecting layer 64 is attached to the cover sheet 60 such that the recording layer 61 faces the cover sheet 60.

Recording and reproduction of information using the recording and reproducing apparatus 100 can be performed by, e.g., the following method. The recording method will be first described.

The light source 1 emits coherent linearly polarized light. The beam expander 20 increases a beam diameter of a light beam emitted from the light source 1, and causes the light beam to enter the retardation element 21 as collimated light.

The light beam which has entered the retardation element 21 exits the retardation element 21 with a polarization plane thereof being rotated, or exits the retardation element 21 as circularly polarized light or elliptically polarized light. That is, the retardation element 21 converts the linearly polarized light into a light having a P-polarized light component whose polarization plane is parallel to a page sheet and an S-polarized light component whose polarization plane is vertical to the page sheet.

Of the light beam transmitted through the retardation element 21, the S-polarized light component is reflected by the polarizing beam splitter 22 and enters the transmission type spatial light modulator 23. The P-polarized light component is transmitted through the polarizing beam splitter 22. The P-polarized light component is utilized as a recording reference light.

The transmission type spatial light modulator 23 can switch the light transmitted therefrom between the P-polarized light component and the S-polarized light component for each pixel. When recording, by appropriately driving the transmission type spatial light modulator 23, the S-polarized light component which has entered the transmission type spatial light modulator 23 is output as an information light having a two-dimensional polarization distribution given thereto in accordance with information to be recorded.

A part of the information light output from the transmission type spatial light modulator 23 is reflected by the beam splitter 24, and enters the converging lens 25 as collimated light. The information light which has entered the converging lens 25 is converted into convergent light, and enters the polarizing beam splitter 26.

The polarizing beam splitter 26 reflects only the S-polarized light component of the information light, and transmits the P-polarized light component therethrough. The S-polarized light component reflected by the polarizing beam splitter 26 enters the split retardation element 27 as an information light having a two-dimensional intensity distribution given thereto.

The S-polarized light component which has entered the right portion 27R of the split retardation element 27 is converted into right-handed circularly polarized light. In contrast, the S-polarized light component which has entered the left portion 27L of the split retardation element 27 is converted into left-handed circularly polarized light.

The right-handed circularly polarized light and the left-handed circularly polarized light from the split retardation element 27 are focused on a position spaced apart from the reflecting layer 63 on the recording layer 61 side of the reflecting layer 63, which is typically the inside of the first protecting layer 62. It is to be noted that the recording medium 6 is arranged such that the cover sheet 60 faces the objective lens 28.

A part of the P-polarized light component (reference light) transmitted through the polarizing beam splitter 22 is reflected by the beam splitter 29, and transmitted through the polarizing beam splitter 26. The reference light transmitted through the polarizing beam splitter 26 then enters the split retardation element 27, and a light component which has entered the right portion 27R is converted into left-handed circularly polarized light whilst a light component which has entered the left portion 27L is converted into right-handed circularly polarized light. These left-handed circularly polarized light and right-handed circularly polarized light are focused on the reflecting layer 63 of the recording medium 6 by the objective lens 28.

In this manner, the information light as the right-handed circularly polarized light and the reference light as the left-handed circularly polarized light are given off from the right portion 27R of the split retardation element 27. In contrast, the information light as the left-handed circularly polarized light and the reference light as the right-handed circularly polarized light are given off from the left portion 27L of the split retardation element 27. Additionally, the information light and the reference light are coaxial.

Therefore, the interference of the information light and the reference light is generated only between the information light as a direct light which has directly entered the recording layer 62 through the cover sheet 60, and the reference light as a reflected light which has been reflected on the reflecting layer 63 and between the reference light as the direct light and the information light as the reflected light. That is, the interference of the information light as the direct light and the information light as the reflected light or the interference of the reference light as the direct light and the reference light as the reflected light is not generated. Therefore, according to the recording and reproducing apparatus 100 shown in FIG. 1, a distribution of optical properties corresponding to the information light can be generated in the recording layer 61.

Light paths of the reference light and the information light will now be described in detail.

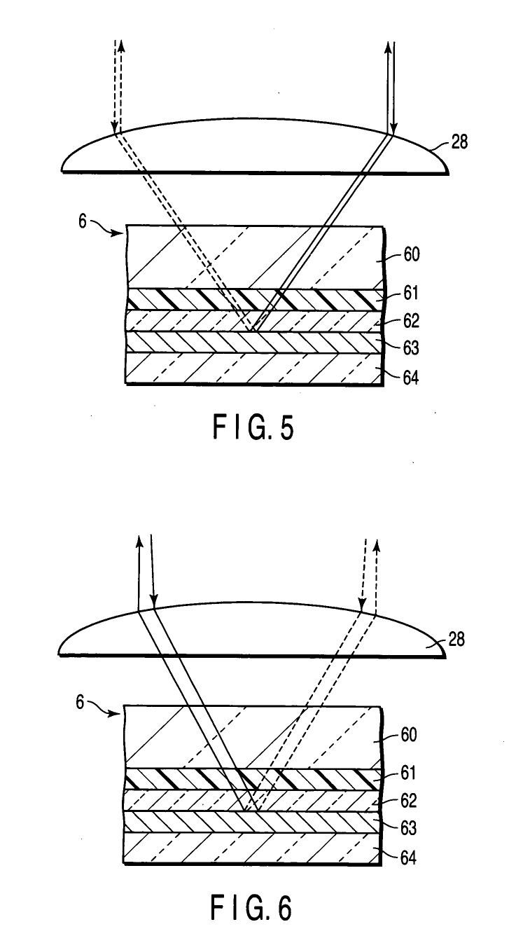

FIG. 5 is a cross-sectional view schematically showing a light path of the reference light. FIG. 6 is a cross-sectional view schematically showing a light path of the information light. It is to be noted that the light path indicated by broken lines is a light path of the right-handed circularly polarized light and a light path indicated by solid lines is a light path of the left-handed circularly polarized light.

As shown in FIG. 5, the reference light is focused on a surface of the reflecting layer 63 which faces the recording layer 61. Therefore, the direct light and the reflected light travel in the same light path in opposed directions.

In contrast, as shown in FIG. 6, the information light is focused on a position apart from the reflecting layer 63 on the recording layer 61 side of the reflecting layer 63, which is the inside of the first protecting layer 62 in this example. Therefore, the light path of the direct light is not equal to the light path of the reflected light. Accordingly, an increasing rate of the beam diameter of the reflected light immediately after exiting from the objective lens 28 is smaller than a decreasing rate of the beam diameter of the direct light before entering the objective lens 28.

In the reproducing method described below, by utilizing the fact that the above difference is reflected in beam diameter increasing rates of the phase conjugate reproduced light and the ordinary reproduced light, separation of the phase conjugate reproduced light and the ordinary reproduced light or the like is performed.

The information recorded by the above described method can be reproduced as follows. That is, the same operation as that in recording is performed expect that the transmission type spatial light modulator 23 is driven such that all pixels thereof output the P-polarized light components. Alternatively, the same operation as that in recording is performed except that an electromagnetic shutter is arranged between the polarizing beam splitter 22 and the beam splitter 24 and the electromagnetic shutter is closed in reproduction. It is to be noted that the electromagnetic shutter is opened in recording. As a result, the reproducing reference light as the P-polarized light component alone reaches the split retardation element 27.

The reproducing reference light then enters the split retardation element 27, and the light component which has entered the right portion 27R is converted into left-handed circularly polarized light whilst the light component which has entered the left portion 27L is converted into right-handed circularly polarized light. These left-handed circularly polarized light and right-handed circularly polarized light are focused on the reflecting layer 63 of the recording medium 6 by the objective lens 28.

An optical property distribution is formed in the recording layer 61 of the recording medium 6 by the above-described method. Therefore, the left-handed circularly polarized light and the right-handed circularly polarized light which have entered the recording medium 6 are partially diffracted by the optical property distribution formed in the recording layer 61 and output as the reproduced light from the recording medium 6.

The left-handed circularly polarized light and the right-handed circularly polarized light output from the recording medium 6 as the reproduced light reach the split retardation element 27 through the objective lens 28. The right-handed circularly polarized light which has entered the right portion 27R of the split retardation element 27 is converted into the S-polarized light component. In contrast, the left-handed circularly polarized light which has entered the left portion 27L of the split retardation element 27 is converted into the S-polarized light component. In this manner, the reproduced light as the S-polarized light component can be obtained.

Thereafter, the reproduced light enters the polarizing beam splitter 26. Since the reproduced light is the S-polarized light component, it is reflected by the polarizing beam splitter 26 and transmitted through the converging lens 25. A part of the reproduced light transmitted through the converging lens 25 is transmitted through the beam splitter 24 and reaches the sensing surface of the image sensor 4. The image sensor 4 detects a light intensity distribution of a reproduced image formed on the sensing surface thereof by the reproduced light.

The light path of the reproduced light will now be described in detail.

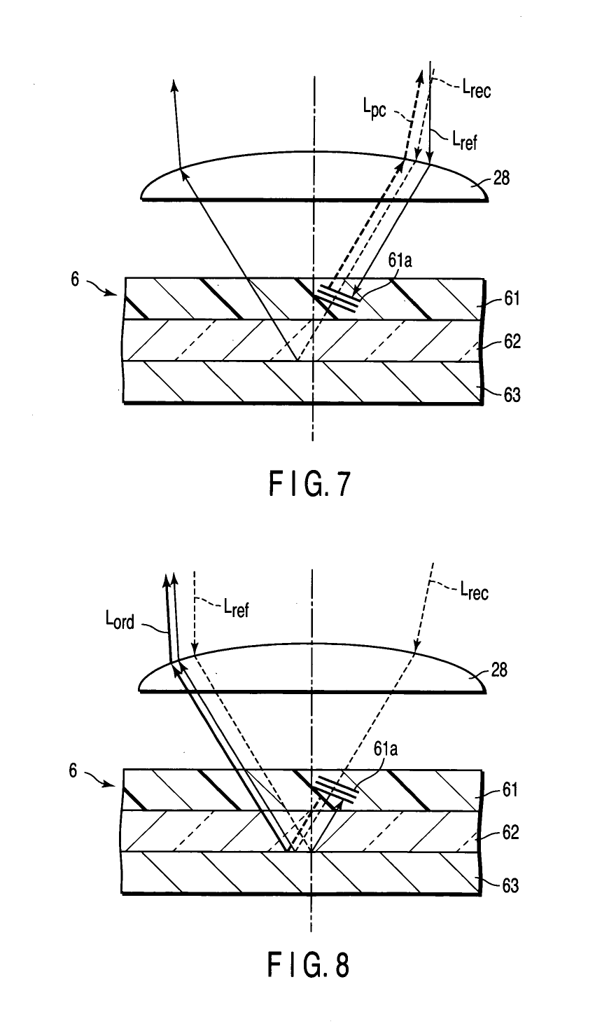

FIGS. 7 to 10 are views schematically showing a relationship between the reproduced light and the optical property distribution formed in the recording layer 61 by the information light which has entered the right portion 27R of the split retardation element 27. It is to be noted that reference character L_{rec} denotes a light path of the information light which is utilized to form the optical property distribution, and an alternate long and short dash line indicates an optical axis of the objective lens 28. Although a description will be given as to a relationship between the reproduced light and the optical property distribution formed in the recording layer 61 by the information light which has entered the right portion 27R of the split retardation element 27, a relationship between the reproduced light and the optical property distribution formed in the recording layer 61 by the information light which has entered the left portion 27L of the split retardation element 27 is the same as this relationship.

An optical property distribution 61a shown in FIGS. 7 and 8 is formed by the information light which has exited the right portion 27 of the split retardation element 27 and is yet to be reflected by the reflecting layer 63, i.e., the direct light. Of the reproducing reference light L_{ref}, the left-handed circularly polarized light from the right portion 27R of the split retardation element 27 is diffracted by the optical property distribution 61a, and produces a phase conjugate reproduced light L_{pc} shown in FIG. 7 as right-handed circularly polarized light when the optical property distribution 61a is independent of the polarization of the recording beam. The phase conjugate reproduced light L_{pc} travels along the light path of the information light L_{rec}, which exits the right portion 27R of the split retardation element 27, in a direction opposite to the information light L_{rec}, and is converted from right-handed circularly polarized light into S-polarized light component when transmitted through the right portion 27R of the split retardation element 27.

In contrast, of the reproducing reference light L_{ref}, the right-handed circularly polarized light which exits the left portion 27L of the split retardation element 27 is reflected by the reflecting layer 63 to become left-handed circularly polarized light, and then diffracted by the optical property distribution 61a, thereby producing the ordinary reproduced light L_{ord} shown in FIG. 8. The ordinary reproduced light L_{ord} travels along the light path of the information light L_{rec}, which exits the right portion 27R of the split retardation element 27, in the same direction as the information light L_{rec}. The ordinary reproduced light L_{ord} is reflected by the reflecting layer 63 to become left-handed circularly polarized light, and then converted from left-handed circularly polarized light into S-polarized light when transmitted through the left portion 27L of the split retardation element 27. Thereafter, the ordinary reproduced light L_{ord} forms a reproduced image.

It is noted that an enlarged image of the reproduced image formed by the ordinary reproduced light L_{ord} and the reproduced image formed by the phase conjugate reproduced light L_{pc} shown in FIG. 7 are symmetrical with respect to a center of the latter reproduced image.

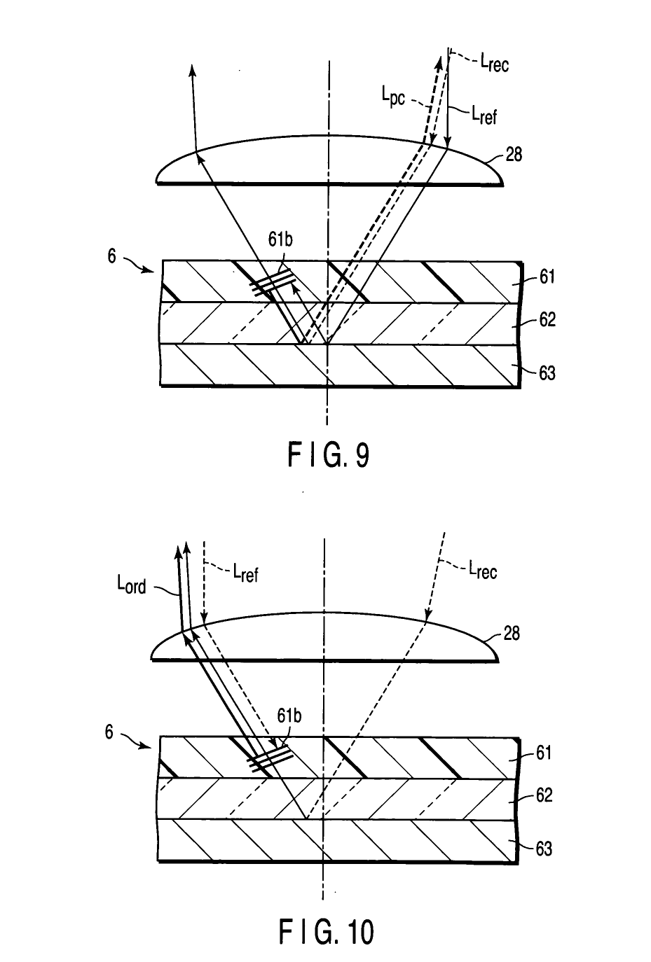

An optical property distribution 61b shown in FIGS. 9 and 10 is formed by the information light transmitted through the right portion 27R of the split retardation element 27 and reflected by the reflecting layer 63, i.e., the reflected light. Of the reproducing reference light L_{ref}, left-handed circularly polarized light from the right portion 27R of the split retardation element 27 is reflected by the reflecting layer 63 to become right-handed circularly polarized light, and then diffracted by the optical property distribution 61b, thereby producing the phase conjugate reproduced light L_{pc} shown in FIG. 9. The phase conjugate reproduced light L_{pc} is equivalent to the phase conjugate reproduced light L_{pc} shown in FIG. 7.

In contrast, of the reproducing reference light L_{ref}, the right-handed circularly polarized light from the left portion 27L of the split retardation element 27 is diffracted by the optical property distribution 61a, thereby producing the ordinary reproduced light L_{ord} shown in FIG. 10. The ordinary reproduced light L_{ord} is equivalent to the ordinary reproduced light L_{ord} depicted in FIG. 8.

In this manner, the recording and reproducing apparatus 100 generates two types of reproduced lights, i.e., the phase conjugate reproduced light L_{pc} and the ordinary reproduced light L_{ord}. The phase conjugate reproduced light L_{pc} travels along the light path of the information light L_{rec} in a direction opposite to the information light, whereas the ordinary reproduced light L_{ord} travels along the light path of the information light L_{rec} in the same direction as the information light.

As described with reference to FIG. 6, an increasing rate of the beam diameter of the information light L_{rec} which travels in the opposite direction immediately after exiting the objective lens 28 is smaller than a decreasing rate of the beam diameter of the information light L_{rec} which travels in the forward direction just before entering the objective lens 28. Therefore, an increasing rate of the beam diameter of the ordinary reproduced light L_{ord} immediately after exiting the objective lens 28 is smaller than an increasing rate of the beam diameter of the phase conjugate reproduced light L_{pc} immediately after exiting the objective lens 28.

The information light L_{rec} traveling in the forward direction is collimated light just before entering the converging lens 25. Therefore, the phase conjugate reproduced light L_{pc} which has entered the converging lens 25 as divergent light exit the converging lens 25 as collimated light. In contrast, since the ordinary reproduced light L_{ord} has a smaller increasing rate of the beam diameter than the phase conjugate reproduced light L_{pc}, it becomes convergent light when transmitted through the converging lens 25. Therefore, the phase conjugate reproduced light L_{pc} forms a larger first reproduced image on the sensing surface of the image sensor 4, and the ordinary reproduced light L_{ord} forms a second reproduced image which has a smaller size and a stronger light intensity than the first reproduced image at a substantially central portion of the first reproduced image.

For imaging the first reproduced image on the image sensor 4, a distance between the converging lens 25 and the image sensor 4 should be equal to a distance between the spatial light modulator 23 and the converging lens 25. Preferably, the former distance is close to a focal length of the converging lens 25.

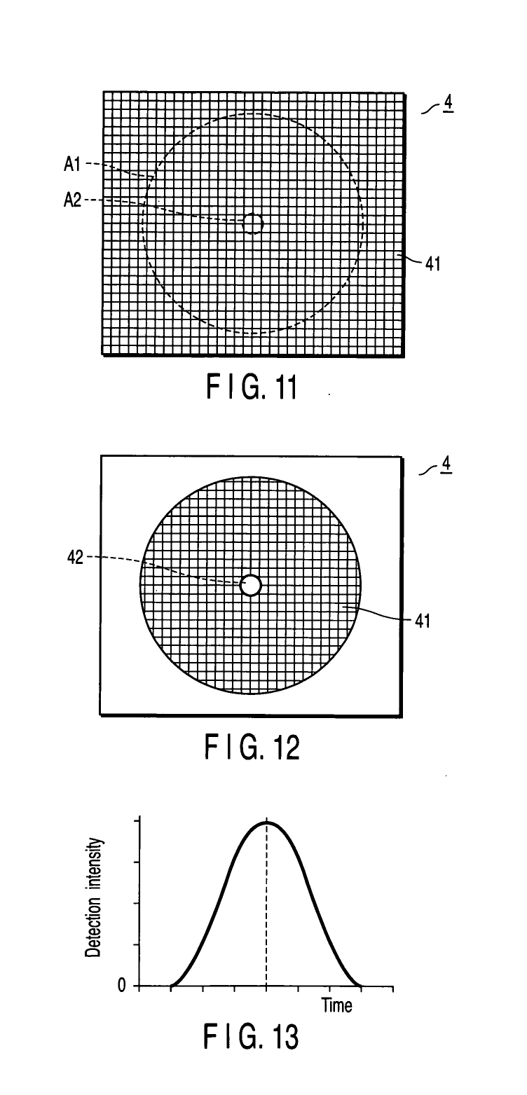

FIG. 11 is a plane view schematically showing an example of the image sensor 4 which can be used in the recording and reproducing apparatus 100 depicted in FIG. 1. As shown in FIG. 11, the sensing surface of the image sensor 4 includes a plurality of pixels 41 arranged in a matrix form.

The phase conjugate reproduced light L_{pc} forms the first reproduced image on an area of the sensing surface of the image sensor 4 which is smaller than the sensing surface, e.g., a substantially circular area A1. The first reproduced image has a light intensity distribution corresponding to a polarization distribution or a light intensity distribution of the information light L_{rec}. A unit area constituting the light intensity distribution corresponds to a pixel of the transmission type spatial light modulator 23. Each pixel 41 of the image sensor 4 has a dimension equal to or smaller than a size of the unit area.

The ordinary reproduced light L_{ord} forms the second reproduced image on an area of the sensing surface of the image sensor 4 which is smaller than an area A1 and positioned at a substantially central portion of the area A1, e.g., a substantially circular area A2. The first and second reproduced images are symmetrical with respect to its center.

It is to be noted that a dimension ratio of the first reproduced image to the second reproduced image, i.e., a dimension ratio of the area A1 to the area A2 can be changed in accordance with, e.g., a focal length of the converging lens 25 or a distance from the converging lens 25 to the image sensor 4. Additionally, the dimension ratio can be changed by arranging, e.g., a lens between the beam splitter 24 and the image sensor 4. When the dimension ratio is increased, a ratio of a light intensity of the second reproduced image to a light intensity of the first reproduced image is increased. A dimension ratio of the second reproduced image to the first reproduced image, i.e., a dimension ratio of the area A2 to the area A1 is usually determined to fall within a range from 0.001 to 0.3. More preferably, it is determined to fall within a range from 0.001 to 0.1.

In this manner, the larger first reproduced image and the smaller second reproduced image are formed on the sensing surface of the image sensor 4. Since the first reproduced image partially overlaps the second reproduced image, information cannot be reproduced from the overlapping portion with a high S/N. That is, if all outputs corresponding to the first reproduced image of the image sensor 4 are utilized for reproduction of information, the information is hard to be reproduced with a high S/N.

In contrast, in this method, the information processor 5 reproduces information using an output from the image sensor 4 corresponding to a non-overlapping portion of the first reproduced image which does not overlap the second reproduced image, i.e., outputs from the pixels 41 positioned in the area A1 and outside the area A2. Therefore, according to this method, a high S/N can be realized in reproduction. It is to be noted that information corresponding to the overlapping portion of the first reproduced image and the second reproduced image is not reproduced, the spatial light modulator 23 is driven such that information to be reproduced corresponds to the non-overlapping portion only.

Meanwhile, in order to obtain an output from the image sensor 4 corresponding to the non-overlapping portion, for example, each unit area constituting the first reproduced image, i.e., an area corresponding to each pixel of the spatial light modulator 23 should accurately match with each pixel 41 of the image sensor 4, and an output from the image sensor 4 corresponding to the non-overlapping portion should be read when the unit areas match with pixels 41 of the image sensor 4. Usually, a dimension of each pixel of the spatial light modulator 23 is approximately several tens of μm, and a dimension of each unit area constituting the first reproduced image is substantially equal to the dimension of each pixel of the spatial light modulator 23. Therefore, when relatively moving the recording medium 6 with respect to the objective lens 28 in reproduction, a high accuracy is required for tracking or control of read timing. Therefore, in order to obtain an output from the image sensor 4 corresponding to the non-overlapping portion, a highly accurate positional adjustment and a highly accurate timing control are required as compared with a positional adjustment which is performed in existing optical recording techniques such as a phase change optical recording technique.

FIG. 12 is a plane view schematically showing another example of the image sensor 4 which can be used in the recording and reproducing apparatus depicted in FIG. 1. The image sensor 4 is substantially the same as the image sensor 4 depicted in FIG. 11 except that it includes a timing signal detecting photodetector having on a sensing surface thereof a detecting portion (or pixels) 42 whose dimension is substantially equal to the second reproduced image. The image sensor 4 is arranged such that the second reproduced image passes across the detecting portion 42 with a relative movement of the recording medium 6 with respect to the objective lens 26 in the track direction when reproducing. Further, a relative position of the detecting portion 42 with respect to an area in which the pixels 41 are arranged is the same as the relative position of the area A2 with respect to the area A1 illustrated in FIG. 11.

FIG. 13 is a graph showing an example of an output from the timing signal detecting photodetector included in the image sensor 4. In the drawing, the abscissa represents time, and the ordinate represents a detection intensity which is an output from the photodetector.

As described above, the second reproduced image has a stronger light intensity than the first reproduced image. Therefore, in reproduction, an output from the timing signal detecting photodetector changes with time as shown in FIG. 13 when a recording mark formed as an optical property distribution in the recording layer 61 passes in front of the objective lens 28, and it becomes maximum when the recording mark is positioned right in front of the objective lens 28.

As described above, the image sensor 4 is arranged such that the second reproduced image passes across the detecting portion 42 with a relative movement of the recording medium 6 with respect to the objective lens 28 in the track direction when reproducing. Furthermore, a relative position of the detecting portion 42 with respect to the area in which the pixels 41 are arranged is the same as a relative position of the second reproduced image with respect to the first reproduced image. Moreover, relative positions of the second reproduced image to the first reproduced image are the same for all recording marks.

Therefore, if tracking is accurately performed, the non-overlapping portion of the first reproduced image which does not overlap the second reproduced image matches with the area in which the pixels 41 are arranged when an output from the timing signal detecting photodetector becomes maximum. Therefore, an output from the image sensor 4 corresponding to the non-overlapping portion can be obtained by reading an output from each pixel 41 at this point of time. That is, an output from the image sensor 4 corresponding to the non-overlapping portion can be obtained by using the second reproduced image as a timing signal.

It is to be noted that, in the recording and reproducing apparatus 100, the reproducing reference light reflected by the reflecting layer 63 without being diffracted by the optical property distribution in the recording layer 61 becomes P-polarized light component when transmitted through the split retardation element 27. Therefore, the reflected reproducing reference light is transmitted through the polarizing beam splitter 26, and does not form a beam spot on the sensing surface of the image sensor 4. Therefore, even if a diffraction efficiency is small, information can be reproduced without being affected by the reflected reproducing reference light.

The output from the image sensor 4 corresponding to the non-overlapping portion can be likewise obtained by other methods.

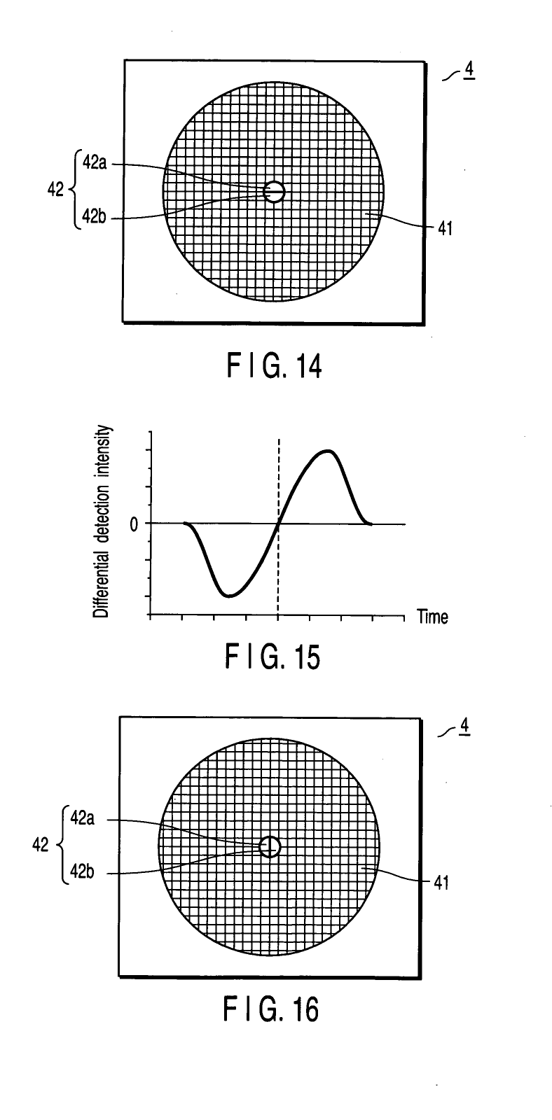

FIG. 14 is a plane view schematically showing still another example of the image sensor 4 which can be used in the recording and reproducing apparatus 100 depicted in FIG. 1. The image sensor 4 has the same structure as the image sensor 4 depicted in FIG. 12 except that the detecting portion 42 is divided into a first detecting portion (or pixels) 42a and a second detecting portion (or pixels) 42b. An area of the first detecting portion 42a is equal to an area of the second detecting portion 42b. The first detecting portion 42a and the second detecting portion 42b are arranged along a movement direction of the second reproduced image with respect to the detecting portion 42. A timing signal detecting photodetector built in the image sensor 4 outputs a difference between an output from the first detecting portion 42a and an output from the second detecting portion 42b. Alternatively, the information processor 5 obtains a difference between an output from the first detecting portion 42a and an output from the second detecting portion 42b.

FIG. 15 is a graph showing an example of an output difference between the first detecting portion 42a and the second detecting portion 42b of the timing signal detecting photodetector included in the image sensor 4 depicted in FIG. 14. In the drawing, the abscissa represents time, and the ordinate represents a difference between an output from the first detecting portion 42a and an output from the second detecting portion 42b, i.e., a differential detection intensity.

When reproducing, as the second reproduced image passes across the second detecting portion 42b and the first detecting portion 42a correspondingly with a relative movement of the recording medium 6 with respect to the objective lens 28 in the track direction, a differential detection intensity varies as shown in FIG. 15, for example. Since the differential detection intensity becomes zero when the recording mark is positioned right in front of the objective lens 28, an output from the image sensor 4 corresponding to the non-overlapping portion of the first reproduced image which does not overlap the second reproduced image can be obtained by reading an output from each pixel 41 at this point of time. That is, an output from the image sensor 4 corresponding to the non-overlapping portion can be obtained by using the second reproduced image as a timing signal.

In the image sensor 4 shown in FIG. 14, the first detecting portion 42a and the second detecting portion 42b are arranged along the movement direction of the second reproduced image with respect to the detecting portion 42. Alternatively, they may be arranged along a direction perpendicular to the movement direction.

FIG. 16 is a plane schematically showing still another example of the image sensor 4 which can be used in the recording and reproducing apparatus depicted in FIG. 1. The image sensor 4 is the same as the image sensor 4 shown in FIG. 14 except that the first detecting portion 42a and the second detecting portion 42b are arranged along a direction perpendicular to the movement direction of the second reproduced image with respect to the detecting portion 42.

When the image sensor 4 shown in FIG. 16 is used, an output from the image sensor 4 corresponding to the non-overlapping portion of the first reproduced image which does not overlap the second reproduced image can be obtained by the same method as that described with reference to FIGS. 12 and 13 except that an output from the first detecting portion 42a and an output from the second detecting portion 42b are used. That is, the information processor 5 obtains a sum of an output from the first detecting portion 42a and an output from the second detecting portion 42b, reads an output from each pixel 41 when the sum becomes maximum. As a result, it is possible to obtain an output from the image sensor 4 corresponding to the non-overlapping portion of the first reproduced image which does not overlap the second reproduced image.

Further, using the image sensor 4 shown in FIG. 16 enables tracking utilizing the second reproduced image.

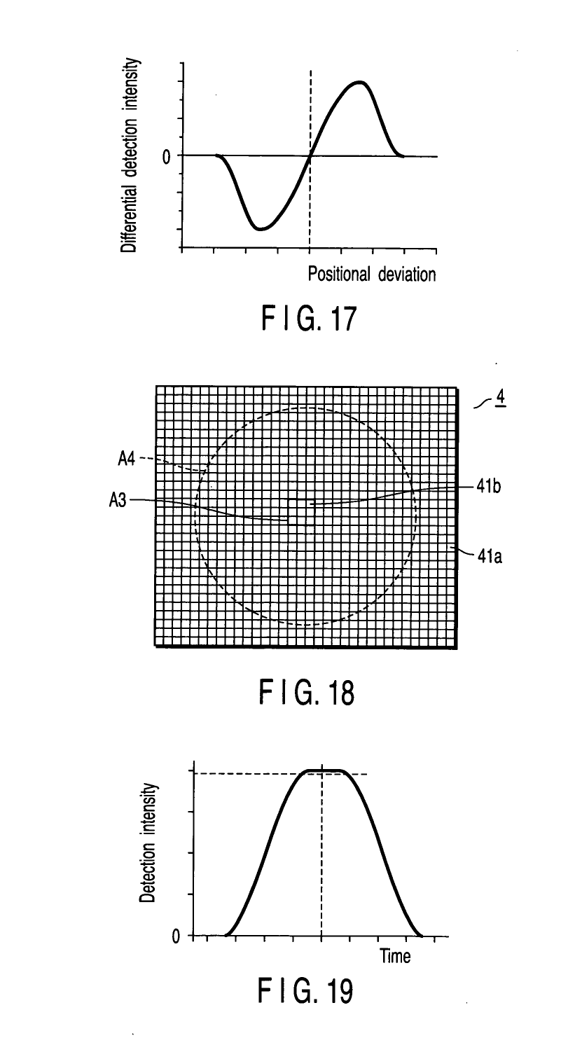

FIG. 17 is a graph showing an example of an output difference between the first detecting portion 42a and the second detecting portion 42b of the timing signal detecting photodetector built in the image sensor 4 shown in FIG. 16. In the drawing, the abscissa represents a positional deviation between a central line of a recording track and the objective lens 28, and the ordinate represents a difference between an output from the first detecting portion 42a and an output from the second detecting portion 42b, i.e., a differential detection intensity.

When the objective lens 28 is relatively moved with respect to the recording medium 6 in a direction perpendicular to a track direction in a state that the recording mark is positioned substantially right in front of the objective lens 28, a differential detection intensity varies as shown in FIG. 17, for example. That is, the differential detection intensity becomes zero when the central line of the recording track is positioned right in front of the objective lens 28. Moreover, when the central line of the recording track deviates from an optical axis of the objective lens 28, the differential detection intensity varies in accordance with the positional deviation. Additionally, the differential detection intensity takes either a positive value or a negative value in accordance with a direction in which the central line of the recording track deviates from the optical axis of the objective lens 28.

Therefore, the optical axis of the objective lens 28 can be positioned on the central line of the recording track by using the information processor 5 to control an operation of the actuator 30 such that the differential detection intensity becomes substantially zero. That is, tracking using the differential detection intensity as a positional error signal (tracking error signal) is possible.

An output from the image sensor 4 corresponding to the non-overlapping portion of the first reproduced image which does not overlap the second reproduced image can be likewise obtained when another structure is employed in the image sensor 4.

FIG. 18 is a plane view schematically showing yet another example of the image sensor 4 which can be used in the recording and reproducing apparatus depicted in FIG. 1. The image sensor 4 includes first pixels 41a and second pixels 41b which are arranged in a matrix form on a sensing surface thereof. The first pixels 41a are arranged in a row direction and a column direction in an area which is substantially equal to or larger than the first reproduced image. Each first pixel 41a has a dimension which is equal to or smaller than a size of a unit area constituting a light intensity distribution of the first reproduced image. In contrast, the second pixels 41b are arranged in the row direction and the column direction in an area A3 which is slightly larger than the second reproduced image. Usually, the second pixel 41b has a sensitivity lower than that of the first pixel 41a. It is to be noted that, in FIG. 18, reference character A4 denotes an area in the sensing surface of the image sensor 4 where the first reproduced image is formed when a center of the area A3 is matched with a center of the second reproduced image.

FIG. 19 is a graph showing an example of a sum of outputs from the second pixels 41b. In the drawing, the abscissa represents time, and the ordinate represents a detection intensity which is a sum of outputs from the second pixels 41b.

When the recording mark passes substantially right in front of the objective lens 28, a sum of outputs from the second pixels 41b varies as shown in, e.g., FIG. 19. That is, the detection intensity becomes substantially maximum when the recording mark is positioned substantially right in front of the objective lens 28. However, the second pixels 41b are arranged in the area which is slightly larger than the second reproduced image. Therefore, it is difficult to accurately obtain the timing signal or the positional error signal from a sum of outputs from the second pixels 41b alone. Thus, for example, simultaneously with or after roughly obtaining the timing signal and the positional error signal from a sum of outputs from the second pixels 41b, the following processing may be carried out in the information processor 5.

That is, a reference value is set for a sum of outputs from the second pixels 41b in advance. The reference value should be a sufficiently large value such that the sum of outputs from the second pixels exceeds the reference value only when the recording mark is positioned substantially right in front of the objective lens 28. For example, as indicated by broken lines in FIG. 19, a reference value is set with respect to a sum of outputs from the second pixels 41b, i.e., the detection intensity.

At the point when the sum of outputs from the second pixels 41b exceeds the reference value, a light intensity distribution of the second reproduced image is obtained from respective outputs from the second pixels 41b. Then, a relative position of the center of the second reproduced image with respect to the sensing surface of the image sensor 4 at the point of time is obtained from the light intensity distribution.

The relative position can be written by using the Cartesian coordinates (X, Y) in which axes are a movement direction of the second reproduced image on the sensing surface of the image sensor 4 and a direction perpendicular thereto. For example, when a center of the area in which the second pixels 41b are arranged has a coordinate (0, 0), X corresponds to an error of a timing signal. Therefore, the timing signal can be corrected by using X. Further, when the center of the area in which the second pixels 41b are arranged has a coordinate (0, 0), Y can be utilized as a positional error signal.

Therefore, by performing tracking using Y as the positional error signal and correcting the timing signal by using X, it is possible to match the center of the second reproduced image with the center of the area in which the second pixels 41b are arranged, and an outputs from the first pixels 41a at this point of time can be read. That is, it is possible to obtain an output from the image sensor 4 corresponding to the non-overlapping portion of the first reproduced image which does not overlap the second reproduced image.

In the method described in conjunction with FIGS. 18 and 19, a shade which appears in the first reproduced image can be utilized for tracking.

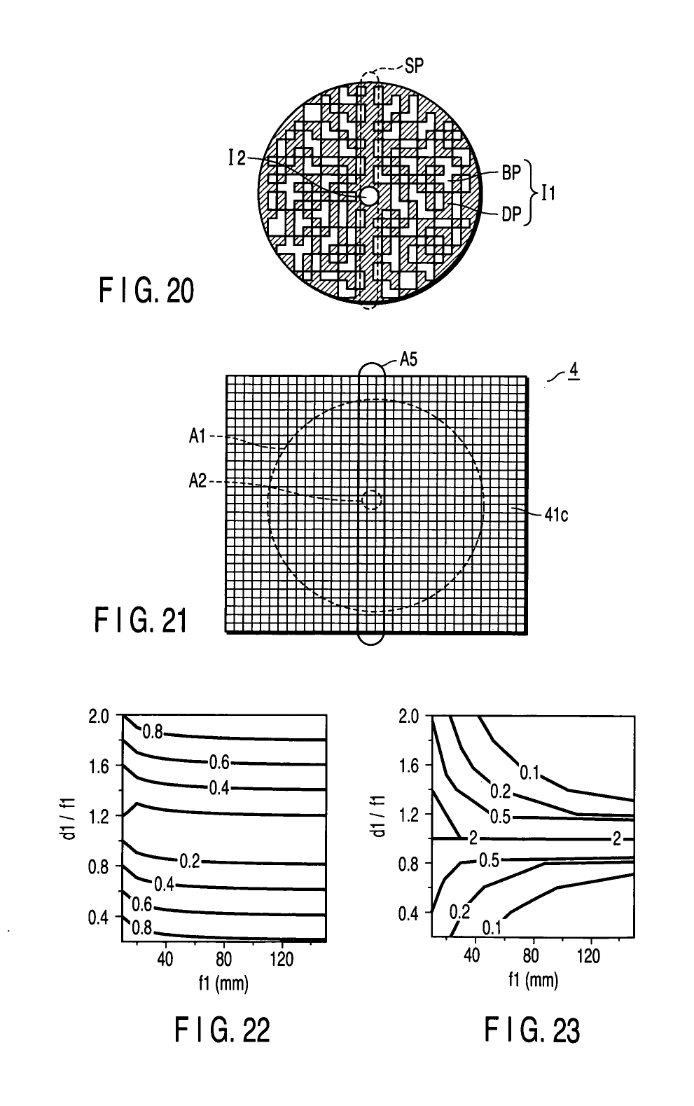

FIG. 20 is a plane view schematically showing an example of a reproduced image which the phase conjugate reproduced light forms on the sensing surface of the image sensor 4. In FIG. 20, reference character I1 denotes the first reproduced image, and reference character I2 designates the second reproduced image. Moreover, in FIG. 20, reference character BP denotes a bright portion of the first reproduced image I1, and reference character DP designates a dark portion of the first reproduced image I1. It is to be noted that FIG. 20 does not illustrate an area around the first reproduced image I1, but an area between a given first reproduced image I1 and a next first reproduced image I1 is usually a dark portion.

When the split retardation element 27 is used, a band-like shade SP which extends across a center of the first reproduced image I1 is usually generated as shown in FIG. 20. The shade SP is not generated when a light path of the recording reference light and a light path of the reproducing reference light match with each other in the wavelength order and volume of the recording layer 61 does not change before and after recording at all. In fact, however, this is not possible, and the band-like shade SP appears in the first reproduced image I1.

A relative position of the shade SP with respect to the sensing surface of the image sensor 4 varies in accordance with a deviation of an optical axis of the objective lens 28 from a central line of the recording track. Additionally, a direction along which the relative position varies can be matched with a width direction of the shade SP by arranging the split retardation element 27 such that a boundary between the right portion 27R and the left portion 27L is parallel to the recording track. Therefore, a positional deviation of the shade SP in the width direction with respect to the center of the area in which the second pixels 41b are arranged may be obtained from outputs from the first pixels 41a, and tracking may be carried out based on the positional deviation. Alternatively, the thus obtained positional deviation may be accessorily utilized in tracking described with reference to FIGS. 18 and 19.

For example, pixel groups each composed of the pixels 41a which form a line in a direction parallel to the shade SP are defined, and a sum of outputs from the pixels 41a included in each pixel group is obtained. The center of the first reproduced image passes on the pixel group which corresponds to the minimum value of the sums. Therefore, by specifying the pixel group corresponding to the minimum value, the center of the first reproduced image can be determined.

An output from the image sensor 4 corresponding to the non-overlapping portion of the first reproduced image and the second reproduced image can be likewise obtained when another structure is employed in the image sensor 4.

FIG. 21 is a plane view schematically showing yet another example of the image sensor 4 which can be used in the recording and reproducing apparatus 100 depicted in FIG. 1. The image sensor 4 includes pixels 41c arranged in a matrix form on the sensing surface thereof. The sensitivity of these pixels 41c can be changed.

When the image sensor 4 is used, an output from the image sensor 4 corresponding to the non-overlapping portion of the first reproduced image which does not overlap the second reproduced image can be obtained by, e.g., the following method. That is, before obtaining the output corresponding to the non-overlapping portion, each pixel 41c is set to the low sensitivity, and a sum of outputs from all the pixels 41c included in a band-like area A5 is detected.

When the recording mark passes substantially right in front of the objective lens 28, a sum of outputs from all the pixels 41c included in the area A5 varies as shown in FIG. 19, for example. That is, a detection intensity becomes substantially maximum when the recording mark is positioned substantially right in front of and/or in the vicinity of the objective lens 28. A reference value is also previously set for the sum of outputs like the method described with reference to FIGS. 18 and 19.

When the sum of outputs from all the pixels 41c included in the area A5 exceeds the reference value, a light intensity distribution of the second reproduced image is obtained from respective outputs from the pixels 41c included in the area A5. Then, a relative position of the center of the second reproduced image with respect to the sensing surface of the image sensor 4 at that point of time is obtained from the light intensity distribution.

A timing signal and a positional error signal are obtained from the relative position by the same method as that described with reference to FIGS. 18 and 19. Tracking is carried out by using the positional error signal. Further, in addition to this, outputs from the pixels 41c corresponding to the non-overlapping portion of the first reproduced image which does not overlap the second reproduced image are read by utilizing the timing signal, for example, when the center of the second reproduced image matches with the center of the area A5. That is, outputs from the pixels 41c positioned in the area A1 and outside the area A2 are read. At this moment, these pixels 41c are set to the high sensitivity. In this manner, the output from the image sensor 4 corresponding to the non-overlapping portion of the first reproduced image which does not overlap the second reproduced image can be obtained.

Of the pixels 41c included in the area A5, pixels 41c which are not irradiated with the ordinary reproduced light may be set to the high sensitivity if a width of the area A5 is wider than the width of the above-described shade SP. In this case, the shade SP can be accessorily utilized for tracking, as in the example described in conjunction with FIG. 20.

When the second reproduced image I2 is detected by using a plurality of pixels, a design dimension of the second reproduced image I2 may be stored in the information processor 5, and the objective lens 28 may be moved in a direction perpendicular to the main surface of the recording medium 6 such that a difference between the design dimension and an actually measured dimension of the second reproduced image I2 obtained from the output of the image sensor 4 becomes substantially zero, where the actually measured dimension is determined from the number of pixels whose output exceeds a predetermined value. Based on this, a focusing deviation can be corrected. That is, the second reproduced image I2 can be used as a focus error signal.

As described above, in this embodiment, the information light is focused on a position away from the reflecting layer 63 on the front side of the reflecting layer 63 when recording, thereby making the light path of the phase conjugate reproduced light different from the light path of the ordinary reproduced light. Although a position on which the information light is focused is not restricted as long as it is spaced away from the reflecting layer 63 on the front side of the reflecting layer 63, focusing the information light on the position in the vicinity of the reflecting layer 63 is advantageous in light of the recording density. This will now be described.

For example, if the information light is focused on the position away from the recording layer 61 on the front side of the recording layer 61, the information light first enters the recording layer 61 as divergent light, is then reflected by the reflecting layer 63, and thereafter again enters the recording layer 61 as divergent light. A beam diameter of the information light as the reflected light in the recording layer 61 is considerably larger than a beam diameter of the information light as a direct light in the recording layer 61. Therefore, a light intensity of the information light as the reflected light is greatly different from a light intensity of the reference light as a direct light, and an interference pattern is hard to be formed. That is, it is hard to make a majority of the information light as the reflected light and the reference light as the direct light to contribute to formation of the recording mark. The recording light which does not contribute to formation of the recording mark affects a material of the recording layer 61. To be more specific, the recording light causes an irreversible reaction of the material.

Meanwhile, in the holographic recording mode, multi-recording by which the recording marks are partially superimposed on one another is possible, and the recording density can be improved by increasing the multiplicity. The multiplicity can be estimated from M/# for the recording layer 61. It is to be noted that M/# can be obtained by the following equation (1). In the equation (1), ηᵢ is a diffraction efficiency of an i-th recording mark.

$$M / \# = {\sum }_{i} {η}_{i}^{1 / 2} \qquad ( 1 )$$

If the diffraction efficiency required for each recording mark is fixed, the high multiplicity can be realized by using the recording layer 61 having large M/#. However, in cases where the greater part of the recording light cannot be made to contribute to formation of the recording mark, even if the recording layer 61 having large M/# is used, the high multiplicity cannot be realized. That is, when the information light is focused on position away from the recording layer 61 on the front side of the recording layer 61, the high multiplicity cannot be realized.

In contrast, for example, when the information light is focused on the position in the first protecting layer 62, a beam diameter of the information light as the reflected light in the recording layer 61 can be set substantially equal to a beam diameter of the information light as the direct light in the recording layer 61. Therefore, the greater part of the information light as the reflected light can interfere with the recording reference light in the recording layer 61. That is, when the information light is focused on the position in the vicinity of the reflecting layer 63, the greater part of information light as the reflected light as well as the information light as the direct light can contribute to formation of the recording mark. Therefore, the high multiplicity can be realized.

This will now be described in detail hereinafter.

A beam diameter of the information light can be obtained by using, e.g., an ABCD method. An optical length d₁ from the converging lens 25 to the objective lens 28, an optical length x from the objective lens 28 to a given position on the optical axis of the objective lens 28, a beam diameter r of the information light at the aforesaid position, a differential r′ of the beam diameter r with respect to the optical length x, and a beam diameter r₀ of the linearly polarized light immediately after exiting from the polarizing beam splitter 22 have a relationship represented by the following equation (2).

$$( \begin{matrix}r \\ {r}^{′}\end{matrix} ) = ( \begin{matrix}1 - \frac{x}{{f}_{2}} & x \\ - \frac{1}{{f}_{2}} & 1\end{matrix} ) ( \begin{matrix}1 - \frac{{d}_{1}}{{f}_{1}} & {d}_{1} \\ - \frac{1}{{f}_{1}} & 1\end{matrix} ) ( \begin{matrix}{r}_{0} \\ 0\end{matrix} ) \qquad ( 2 )$$

In equation (2), a consideration is given to an example in which d₁=12 mm, f₁=100 mm, f₂=2 mm, a thickness of the objective lens 28 is ignored and a distance from the objective lens 28 to the reflecting layer 63 is matched with a focal length f₂. In this case, the beam diameter r of the information light is 0.88×r₀ on the incident surface (x=0 mm) of the objective lens 28, and it is −0.02×r₀ on the surface (x=f₂) of the reflecting layer 63. Furthermore, the beam diameter r of the information light reflected by the reflecting layer 63 is −0.92×r₀ on the incident surface (x=2×f₂) of the objective lens 28. It is to be noted that a minus sign given to the beam diameter r means that the information light is reversed with respect to the optic axis.

In this manner, when the distance from the objective lens 28 to the reflecting layer 63 is matched with the focal length f₂, i.e., when the reference light which has entered the objective lens 28 as a collimated light is converged on the surface of the reflecting layer 63, the beam diameter of the information light as the direct light at a position of the objective lens 28 is substantially equal to the beam diameter of the information light as the reflected light at the position of the objective lens 28. Moreover, the beam diameter of the recording reference light at the position of the objective lens 28 is r₀ regardless of whether the recording reference light is the direct light or the reflected light. That is, in this case, the greater part of the information light as the reflected light as well as the information light as the direct light can contribute to formation of the recording mark. Therefore, the high multiplicity can be realized.

The optical length do from the reflecting layer 63 to the position on which the information light is focused can be obtained from the following equation (3). That is, in the following equation (3), assuming that d₁=12 mm, f₁=100 mm and f₂=2 mm as in the above example, d₀=44 μm is achieved.

$$( \begin{matrix}0 \\ {r}^{′}\end{matrix} ) = ( \begin{matrix}1 - \frac{{f}_{2} - {d}_{0}}{{f}_{2}} & {f}_{2} - {d}_{0} \\ - \frac{1}{{f}_{2}} & 1\end{matrix} ) ( \begin{matrix}1 - \frac{{d}_{1}}{{f}_{1}} & {d}_{1} \\ - \frac{1}{{f}_{1}} & 1\end{matrix} ) ( \begin{matrix}{r}_{0} \\ 0\end{matrix} ) \qquad ( 3 )$$

Various kinds of values were calculated by using equations (2) and (3) with the focal length f₁ of the converging lens 25 and the optical length d₁ from the converging lens 25 to the objective lens 28 being utilized as parameters. It is to be noted that a focal length f₂ of the objective lens 28 was determined as 2 mm. FIGS. 22 to 24 show results of the calculation.

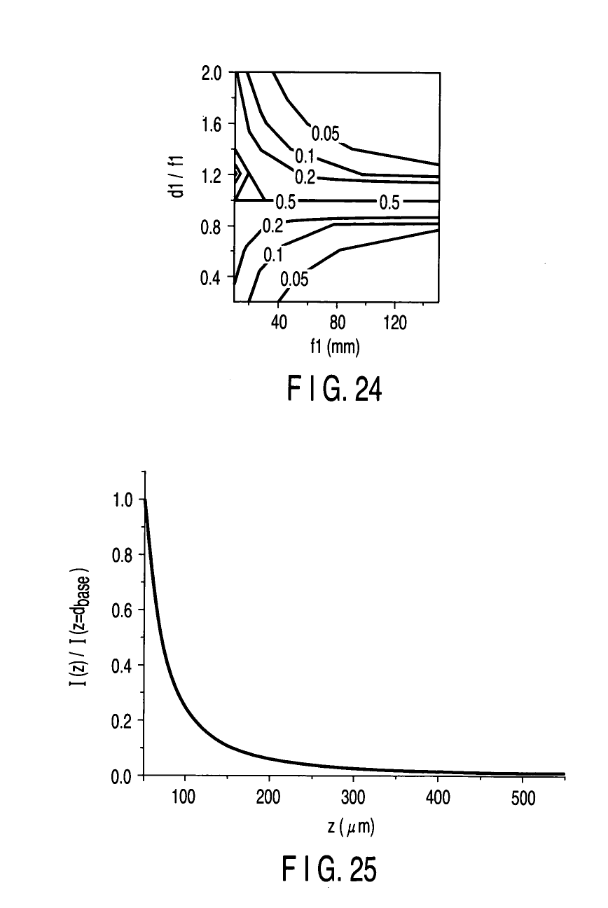

FIG. 22 is a graph showing a ratio (|rᵢₙ|+|rₒᵤₜ|)/(2×r₀) of an average beam diameter, which is an average of a beam diameter rᵢₙ of the information light as the direct light and a beam diameter rout of the information light as the reflected light at the position of the objective lens 28, to a beam diameter r₀ of the linearly polarized light immediately after exiting the polarizing beam splitter 22. FIG. 23 is a graph showing an optical length do from the reflecting layer 63 to a position on which the information light is focused. FIG. 24 is a graph showing an absolute value of a common logarithm of a ratio |rᵢₙ|/|rₒᵤₜ| which is a ratio of the beam diameter rᵢₙ of the information light as the direct light and the beam diameter rout of the information light as the reflected light at the position of the objective lens 28.

In each of FIGS. 22 to 24, the abscissa represents a focal length f₁ of the converging lens 25, and the ordinate represents a ratio d₁/f₁ of the optical length d₁ from the converging lens 25 to the objective lens 28 to the focal length f₁. A numeric character given to each curve indicates a ratio (|rᵢₙ|+|rₒᵤₜ|)/(2×r₀) in FIG. 22, a numeric character given to each curve indicates an absolute value (μm) of the optical length d₀ in FIG. 23, and a numeric character given to each curve indicates an absolute value of a common logarithm of the ratio |rᵢₙ|/|rₒᵤₜ| in FIG. 24.

As apparent from FIGS. 22 and 23, the ratio (|rᵢₙ|+|rₒᵤₜ|)/(2×r₀) becomes smaller when the optical length d₀ is elongated. Additionally, as apparent from FIGS. 23 and 24, if the optical length d₀ is long, an absolute value of the common logarithm of the ratio |rᵢₙ|/|rₒᵤₜ| is large no matter what value the beam diameter r₀ of the linearly polarized light immediately after exiting the polarizing beam splitter 22 takes. That is, if the optical length d₀ is long, the greater part of the information light cannot contribute to formation of the recording mark. Therefore, in order to make the greater part of the information light to contribute to formation of the recording mark, it is desirable to reduce the optical length d₀.

Incidentally, assuming that d₁=90 mm, f₁=100 mm and f₂=2 mm, calculating rᵢₙ and rₒᵤₜ from equation (2) results in rᵢₙ=0.1×r₀ and rₒᵤₜ=−0.14×r₀. Furthermore, when d₀ is calculated from equation (3), d₀=333 μm can be obtained. When the optical length d₀ from the reflecting layer 63 to the position on which the information light is focused is long in this manner, the greater part of the information light cannot contribute to formation of the recording mark.

As apparent from the above description, in order to the greater part of the information light to contribute to formation of the recording mark, it is desirable to reduce the optical length d₀ from the reflecting layer 63 to the position on which the information light is focused. However, if the optical length d₀ is extremely short, an optical length from the converging lens 25 to the image sensor 4 must be set sufficiently long in order to well reduce a dimension ratio of the second reproduced image I2 to the first reproduced image I1, i.e., a dimension ratio of the area A2 to the area A1.

Assuming that d₂(=f₂) is an optical length from the objective lens 28 to the reflecting layer 63, d₃ is an optical length from the converging lens 25 to the image sensor 4 and r_{det} is a dimension of the second reproduced image I2 on the sensing surface of the image sensor 4, i.e., a beam diameter of the ordinary reproduced light, the following equation (4) can be achieved.

$$( \begin{matrix}{r}_{det} \\ {r}^{′}\end{matrix} ) = ( \begin{matrix}1 - \frac{{d}_{3}}{{f}_{1}} & {d}_{3} \\ - \frac{1}{{f}_{1}} & 1\end{matrix} ) ( \begin{matrix}1 - \frac{{d}_{1}}{{f}_{2}} & {d}_{1} \\ - \frac{1}{{f}_{2}} & 1\end{matrix} ) ( \begin{matrix}1 - \frac{2 {d}_{2}}{{f}_{2}} & 2 {d}_{2} \\ - \frac{1}{{f}_{2}} & 1\end{matrix} ) ( \begin{matrix}1 - \frac{{d}_{1}}{{f}_{1}} & {d}_{1} \\ - \frac{1}{{f}_{1}} & 1\end{matrix} ) ( \begin{matrix}{r}_{0} \\ 0\end{matrix} ) \qquad ( 4 )$$

For example, in equation (4), assuming that d₁=12 mm, d₃=45 mm, f₁=100 mm and f₂=2 mm, r_{det}=0.01×r₀ can be obtained. A dimension of the first reproduced image I1 on the sensing surface of the image sensor 4, i.e., a beam diameter of the phase conjugate reproduced light is equal to r₀. Therefore, the dimension ratio of the second reproduced image I2 to the first reproduced image I1, i.e., the dimension ratio of the area A2 to the area A1 can be sufficiently reduced by arranging the converging lens 25 sufficiently spaced apart from the image sensor 4.

As described above, when the recording layer 61 having large M/# is used, the high multiplicity can be realized by focusing the information light in the vicinity of the reflecting layer 63. The M/# is a value which is in proportion to a thickness of the recording layer 61. Therefore, in order to realize the high multiplicity, increasing a thickness of the recording layer 61 is advantageous. When a thickness of the recording layer 61 is increased, however, an intensity of the information light on the surface of the recording layer 61 facing the objective lens 28 becomes considerably weaker than an intensity of the information light on the surface of the recording layer 61 facing the reflecting layer 63 as described below.

A consideration will be given as to an example in which light absorption is ignored and the information light is converged on the surface of the reflecting layer 63 without providing the converging lens 25. Assuming that z is a distance from the surface of the reflecting layer 63, z₀ is a focal depth of the objective lens 28, λ is a wavelength of the information light, k is a wave vector of the information light, W₀ is a minimum beam diameter and I(z) is a light intensity at a position apart from the surface of the reflecting layer 63 by the distance z, the following equations (5) and (6) can be attained.
z₀=Πw₀²/λ (5)

$$I ( z ) = \frac{1}{( 1 + {z}^{2} / {z}_{0}^{2} )} ( 1 + cos ( kz ) ) \qquad ( 6 )$$

For example, assuming that a thickness of the first protecting layer 62 is 50 μm and the light intensity I(z) of the information light on the interface between the first protecting layer 62 and the recording layer 61 is I (z=d_{base}), a relationship shown in FIG. 25 can be obtained from equations (5) and (6).

FIG. 25 is a graph showing an example of a relationship between the distance z from the surface of the reflecting layer 63 and the light intensity I(z) at the position apart from the surface of the reflecting layer 63 by the distance z. In the drawing, the abscissa represents the distance z, and the ordinate represents a ratio I(z)/I(z=d_{base}).

As shown in FIG. 25, if the distance z is less than approximately 100 μm, the ratio I(z)/I(z=d_{base}) is very large. If the distance z falls within a range from approximately 100 μm to approximately 300 μm, the ratio I(z)/I(z 32 d_{base}) is sufficiently large. However, as shown in FIG. 25, if the distance z exceeds 300 μm, the ratio I(z)/I(z=d_{base}) is considerably small. That is, if a thickness of the recording layer 61 is set larger than 300 μm, the optical properties cannot be sufficiently changed by light irradiation in a region of the recording layer 61 on the objective lens 28 side, or light irradiation must be carried out for a very long time or a light with high power density must be applied in order to sufficiently change the optical properties.

If the light irradiation time is increased, it is hard to write information at high speed. Further, when photopolymer is irradiated with a light having high power density, reaction does not proceed as expected, and the photopolymer may demonstrate peculiar behavior in some cases. That is, when a thickness of the recording layer 61 is equal to or larger than approximately 300 μm, M/# can be hardly increased even if the thickness of the recording layer 61 is increased. Therefore, the thickness of the recording layer 61 may be set to, e.g., approximately 300 μm or less.

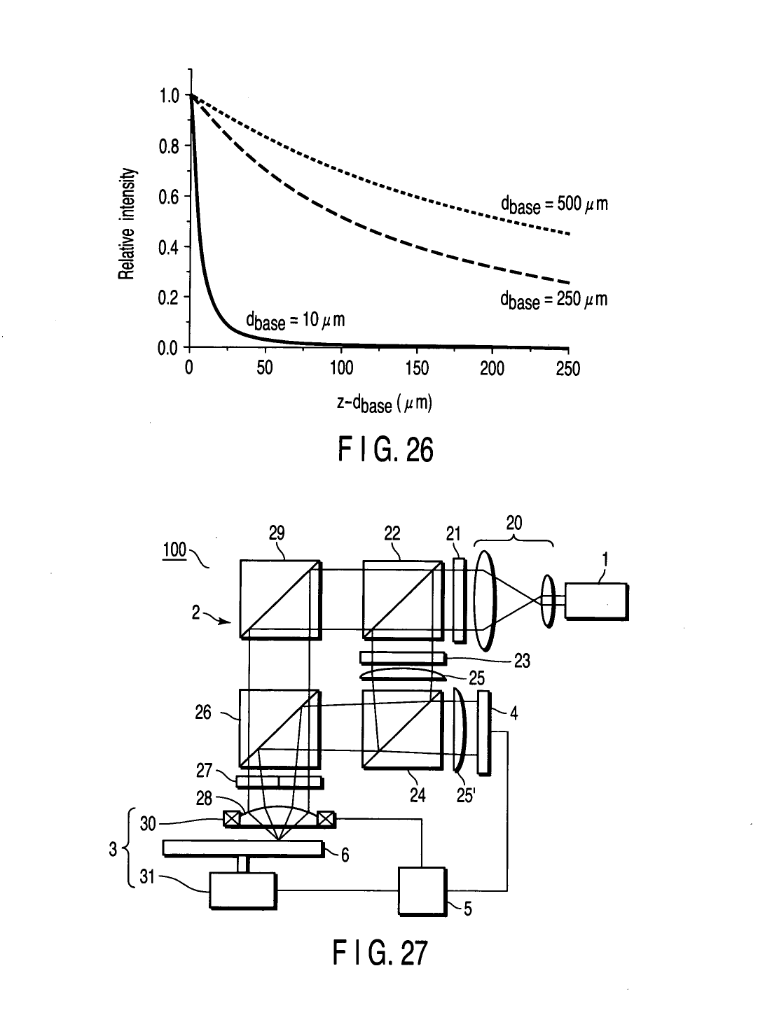

The relationship between the distance z and the ratio I(z)/I(z=d_{base}) shown in FIG. 25 varies in accordance with a thickness of the first protecting layer 62. This will now be described with reference to FIG. 26.

FIG. 26 is a graph showing another example of the relationship between the distance z from the surface of the reflecting layer 63 and the light intensity I(z) at a position apart from the surface of the reflecting layer 63 by the distance z. In the drawing, the abscissa represents a difference z−d_{base} between the distance z and the distance d_{base} from the reflecting layer 63 to the interface between the first protecting layer 62 and the recording layer 61, and the ordinate represents a ratio I(z)/I(z=d_{base}) Furthermore, in FIG. 26, a solid line indicates data when the distance d_{base} is 10 μm, a broken line indicates data when the distance d_{base} is 250 μm, and a dotted line indicates data when the distance d_{base} is 500 μm.

As shown in FIG. 26, when the distance d_{base} is increased, i.e., when a thickness of the first protecting layer 62 is increased, a change rate of the ratio I(z)/I(z=d_{base}) to the difference z−d_{base} is decreased. That is, when the thickness of the first protecting layer 62 is increased, a difference between the intensity of the information light on the surface of the recording layer 61 facing the reflecting layer 63 and the intensity of the information light on the surface of recording layer 61 facing the objective lens 28 can be reduced even if the thickness of the recording layer 61 is increased. For example, when the thickness of the first protecting layer 62 is set substantially equal to or larger than that of the recording layer 61, intensities of the information lights on the both main surfaces of the recording layer 61 can be set substantially equal to each other.

As described above, it is desirable that the optical length d₀ from the reflecting layer 63 to the position on which the information light is focused is short. Moreover, a large thickness of the first protecting layer 62 is desirable. Therefore, typically, the information light is focused in the first protecting layer 62.

In the recording and reproducing apparatus 100 mentioned above, although the λ/4 retardation plate is used for each of the right portion 27R and the left portion 27L of the split retardation element 27, but the λ/2 retardation plate can be likewise used for each of these portions. However, when the λ/2 retardation plate is used for each of the right portion 27R and the left portion 27L of the split retardation element 27, the phase conjugate reproduced light and the ordinary reproduced light are transmitted through the polarizing beam splitter 26. Therefore, in this case, for example, the image sensor 4 should be arranged to receive the phase conjugate reproduced light and the ordinary reproduced light transmitted through the beam splitter 29, and a converging lens should be arranged between the beam splitter 29 and the image sensor 4 besides the converging lens 25. That is, in this case, another converging lens is further required in addition to the converging lens 25. Therefore, positional adjustment of the lens becomes complicated.

In the recording and reproducing apparatus 100, although the ordinary reproduced light is detected by using the image sensor 4, the ordinary reproduced light may be detected by a photodetector which is provided in addition to the image sensor 4. For example, a beam splitter may be arranged between the beam splitter 24 and the image sensor 4 so that the phase conjugate reproduced light transmitted through the beam splitters can be detected by the image sensor 4, and a photodetector may be arranged to receive the ordinary reproduced light reflected by the former beam splitter. In this case, however, the image sensor 4 and the photodetector must be accurately positioned.

A second embodiment according to the present invention will now be described.

FIG. 27 is a view schematically showing a recording and reproducing apparatus according to the second embodiment of the present invention.

The recording and reproducing apparatus 100 has substantially the same structure as the recording and reproducing apparatus 100 depicted in FIG. 1 except that the converging lens 25 is arranged between the spatial light modulator 23 and the beam splitter 24 instead of between the beam splitter 24 and the polarizing beam splitter 26. Even if such a structure is employed, recording and reproduction of information and various kinds of controls can be performed by substantially the same method as that described in conjunction with the first embodiment.

In the present embodiment, as shown in FIG. 27, it is desirable to arrange a converging lens 25′ between the beam splitter 24 and the image sensor 4. For example, when a focal length of the converging lens 25 is equal to a focal length of the converging lens 25′ and optical lengths from the reflecting surface of the beam splitter 24 to these lenses are equal to each other, the ordinary reproduced light which enters the converging lens 25′ as divergent light can exit as collimated light.

In order to form the first reproduced image on the image sensor 4, a distance between the converging lens 25′ and the image sensor 4 should be equal to a distance between the spatial light modulator 23 and the converging lens 25.

In the present embodiment, various kinds of numeric values can be likewise calculated by the same method as that described in conjunction with the first embodiment. For example, it is determined that d₁=24 mm, d₂=f₂, d₃=46 mm, f₁=120 mm and f₂=1.8 mm. Note that d₃ is an optical length from the converging lens 25′ to the image sensor 4 in the present embodiment. Additionally, a focal length of the converging lens 25 is set equal to a focal length of the converging lens 25′, and optical lengths from the reflecting surface of the beam splitter 24 to these lenses are set equal to each other.

By doing so, rᵢₙ=0.8×r₀ and rₒᵤₜ=−0.83×r₀ can be obtained from equation (2). That is, in this case, many information lights as the reflected light as well as the information light as the direct light can be made to contribute to formation of the recording mark. Therefore, the high multiplicity can be realized.

Further, in this case, d₀=33 μm can be obtained from equation (3). When the first protecting layer 62 is set to, e.g., 200 μm, the information light can be focused in the first protecting layer 62.

Furthermore, r_{det}=−0.005×r₀ can be obtained from equation (4). Since a dimension of the first reproduced image I1 is r₀, a dimension ratio of the second reproduced image I2 to the first reproduced image I1, i.e., a dimension ratio of the area A2 to the area A1 can be sufficiently reduced in this case.

A third embodiment will now be described.

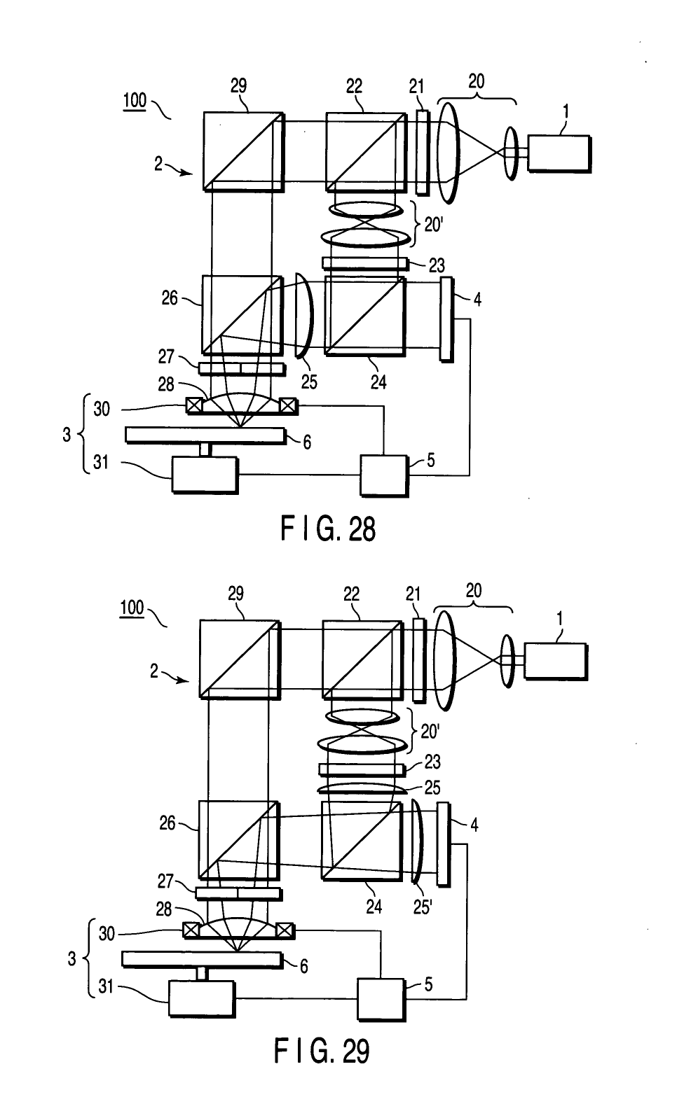

FIG. 28 is a view schematically showing a recording and reproducing apparatus according to a third embodiment of the present invention.

The recording and reproducing apparatus 100 has a structure which is substantially the same as that of the recording and reproducing apparatus 100 depicted in FIG. 1 except that a beam expander 20′ is arranged between the polarizing beam splitter 22 and the spatial light modulator 23. Even if such a structure is employed, recording and reproduction of information and various kinds of controls can be likewise carried out by substantially the same method as that described in conjunction with the first embodiment.

Moreover, in this embodiment, since the beam expander 20′ is arranged between the polarizing beam splitter 22 and the spatial light modulator 23, a beam diameter of the information light which enters the converging lens 25 can be increased as compared with the beam diameter r₀ of each of the recording reference light and the reproducing reference light which enter the polarizing beam splitter 26. Therefore, the overlap of an area which is irradiated with the recording reference light and an area which is irradiated with the information light in the recording layer 61 can be increased.

In this embodiment, various kinds of numeric values can be likewise calculated by the same method as that described in conjunction with the first embodiment. For example, the beam expander 20′ can expand a beam diameter by 1.2 times. Additionally, it is determined that d₁=16 mm, d₂=f₂, d₃=32 mm, f₁=80 mm and f₂=2 mm.

By doing so, rᵢₙ=0.96×r₀ and rₒᵤₜ=−1.02×r₀ can be obtained from equation (2). That is, in this case, many information lights as the reflected light as well as the information light as the direct light can be made to contribute to formation of the recording mark. Therefore, the high multiplicity can be realized.

Further, in this case, d₀=61 μm can be obtained from equation (3). When the first protecting layer 62 is set to, e.g., 200 μm, the information light can be focused in the first protecting layer 62.

Furthermore, r_{det}=−0.01×(1.2×r₀) can be obtained from equation (4). Since the dimension of the first reproduced image I1 is 1.2×r₀, a dimension ratio of the second reproduced image I2 to the first reproduced image I1, i.e., a dimension ratio of the area A2 to the area A1 can be sufficiently reduced.

A fourth embodiment according to the present invention will now be described.

FIG. 29 is a view schematically showing a recording and reproducing apparatus according to the fourth embodiment of the present invention.

The recording and reproducing apparatus 100 has substantially the same structure as that of the recording and reproducing apparatus 100 depicted in FIG. 27 except that the beam expander 20′ is arranged between the polarizing beam splitter 22 and the spatial light modulator 23. Even if such a structure is employed, recording and reproduction of information and various kinds of controls can be effected by substantially the same method as that described in conjunction with the second embodiment.

Moreover, in this embodiment, since the beam expander 20′ is arranged between the polarizing beam splitter 22 and the spatial light modulator 23, a beam diameter of the information light which enters the converging lens 25 can be set larger than a beam diameter r₀ of each of the recording reference light and the reproducing reference light which enter the polarizing beam splitter 26. Therefore, the overlap of an area which is irradiated with the recording reference light and an area which is irradiated with the information light can be increased in the recording layer 61.

In this embodiment, various kinds of numeric values can be likewise calculated by the same method as that described in the first embodiment. For example, it is determined that the beam expander 20′ expands a beam diameter by 1.5 times, and d₁=30 mm, d₂=f₂, d₃=18 mm, f₁=80 mm and f₂=2 mm. Note that d₃ is an optical length from the converging lens 25′ to the image sensor 4 in this embodiment. Additionally, a focal length of the converging lens 25 is set equal to a focal length of the converging lens 25′, and an optical length from the reflecting surface of the beam splitter 24 to the converging lens 25 is set equal to an optical length from the reflecting surface of the beam splitter 24 to the converging lens 25′.

By doing so, rᵢₙ=0.94×r₀ and rout=−1.01×r₀ can be obtained from equation (2). That is, in this case, many information lights as the reflected light as well as the information light as the direct light can be made to contribute to formation of the recording mark.

Further, in this case, d₀=77 μm can be obtained from equation (3). When the first protecting layer 62 is set to, e.g., 200 μm, the information light is focused in the first protecting layer 62.

Furthermore, r_{det}=−0.007×(1.5×r₀) can be obtained from equation (4). Since a dimension of the first reproduced image is 1.5×r₀, a dimension ratio of the second reproduced image I2 to the first reproduced image I1, i.e., a dimension ratio of the area A2 to the area A1 can be sufficiently reduced in this case.

Providing the recording and reproducing apparatus 100 with the beam expander 20′ described in conjunction with the third and fourth embodiments is advantageous to give the compatibility with an existing optical recording system to the recording and reproducing apparatus 100 as described below.

For example, an objective lens which is mounted in a current digital versatile disk (DVD) drive has a diameter of approximately 3 mm. Therefore, when giving the compatibility with the DVD system to the recording and reproducing apparatus 100, a diameter of the objective lens 28 is determined as approximately 3 mm.

However, the spatial light modulator 23 includes many pixels, and a dimension of each pixel is larger than 10 μm in general. That is, a beam diameter of the information light is usually larger than the diameter of the objective lens 28 immediately after output from the spatial light modulator 23. In this case, pixels of the spatial light modulator 23 cannot be effectively utilized.

When the beam expander 20′ is arranged between the polarizing beam splitter 22 and the spatial light modulator 23 and the converging lens 25 is arranged between the spatial light modulator 23 and the polarizing beam splitter 26, light having a sufficiently large beam diameter can be caused to enter the spatial light modulator 23, and information light having a sufficiently small beam diameter can be caused to enter the objective lens 28. Therefore, pixels of the spatial light modulator 23 can be effectively utilized without changing a diameter of the objective lens 28.

For example, as described in connection with the fourth embodiment, when the beam expander 20′ expands a beam diameter by 1.5 times, a cross-sectional area of the light beam which enters the spatial light modulator 23 becomes 1.5² times. In this case, therefore, if the number of pixels of the spatial light modulator 23 which can be used for recording is increased approximately twofold, a transfer rate is also increased approximately twofold as compared with an example in which the beam expander 20′ is not provided.

### EXAMPLE 1

In regard to the recording and reproducing apparatus 100 depicted in FIG. 1, a fact that a high S/N can be realized in reproduction was confirmed by the following method.

First, the recording medium 6 depicted in FIG. 3 was manufactured by the following method. That is, an A1 alloy layer 63 having a thickness of 100 nm and a ZnS:SiO₂ layer 64 having a thickness of 200 nm were sequentially formed on a polycarbonate substrate 62 having a thickness of 0.6 mm by a sputtering method. Incidentally, as the polycarbonate substrate 62, used was a substrate having a groove 65 shown in FIG. 4 spirally provided on a surface thereof on which the A1 alloy layer 63 is formed. A recording layer 61 with a thickness of 200 μm made of HRF-700 as photopolymer manufactured by Dupont was interposed between the polycarbonate substrate 62 and a cover sheet 60 having a thickness of 400 μm.

The recording medium 6 was mounted in the recording and reproducing apparatus 100 shown in FIG. 1, and recording of information and reproduction of the recorded information were performed. In this example, as the light source 1, a semiconductor laser whose power was approximately 100 mW and which was provided wit an external resonator was used. A transmission type liquid crystal display having 800×600 pixels was used as the spatial light modulator 23, and a structure shown in FIG. 18 was employed in the image sensor 4. Further, in this example, d₁=12 mm, d₂=f₂, d₃=45 mm, f₁=100 mm and f₂=2 mm. In this case, rᵢₙ=0.88×r₀, rₒᵤₜ=−0.92×r₀, d₀=44 μm, r_{det}=0.01×r₀.

When recording, the recording medium 6 was rotated at a linear velocity of 0.1 m/s. Information was written by stopping rotation of the recording medium 6 when a center of the recessed portion 65a of the groove 65 was positioned on the optical axis of the objective lens 28. At this time, the recording reference light reflected by the reflecting layer 63 and transmitted through the beam splitter 29 was detected by a non-illustrated split photodetector, and focusing, tracking and a write timing control were carried out by using the same method as that of the DVD.

When reproducing, the recording medium 6 was rotated at a linear velocity of 0.1 m/s. Focusing, tracking and a read timing control were carried out by the method described with reference to FIGS. 18 and 19. Under such conditions, outputs from the first pixels 41a positioned in the area A4 were read, and information was reproduced from these outputs. As a result, S/N in reproduction was 3.1 dB. Here, the S/N is a quantity defined by the following equation when using an average μ_{ON} and a dispersion σ_{ON} of outputs from pixels corresponding to the bright portion BP and an average μ_{OFF} and a dispersion σ_{OFF} of outputs from pixels corresponding to the dark portion DP among the first pixels 41a.
SNR=(μ_{ON}−μ_{OFF})/(σ_{ON}²+σ_{OFF}²)^{1/2} (7)

### EXAMPLE 2

FIG. 31 is a view schematically showing a recording and reproducing apparatus according to Example 2 of the present invention. The recording and reproducing apparatus shown in FIG. 31 has the same structure as that of the recording and reproducing apparatus 100 depicted in FIG. 1 except that a pair of convex lenses 25a and 25b are arranged between the beam splitter 24 and the polarizing beam splitter 26 in place of the converging lens 25. In regard to the recording and reproducing apparatus 100, a fact that a high S/N can be realized in reproduction was confirmed by the following method.

The recording medium 6 manufactured as in Example 1 was mounted in the recording and reproducing apparatus 100 shown in FIG. 31, and recording of information and reproduction of the recorded information were carried out. In this example, as the light source 1, a semiconductor laser whose power was approximately 100 mW and which was provided with a cavity was used. A transmission type liquid crystal display having 800×600 pixels was used as the spatial light modulator 33, and the structure shown in FIG. 18 was employed in the image sensor 4. Here, assuming that f₁ₐ and f_{1b} are focal lengths of the convex lenses 25a and 25b, f₂ is a focal length of the objective lens 28, l₁ is a distance from the convex lens 25a to the convex lens 25b, l₂ is a distance from the convex lens 25 to the objective lens 28, l₃ is a distance from the objective lens 28 to the reflecting surface of the recording medium 6 and l₄ is a distance from the objective lens 25 to the image sensor 4, it is determined that l₁=35 mm, l₂=14 mm, l₃=f₂, l₄=17 mm, f₁ₐ=15 mm, f_{1b}=15 mm and f₂=2 mm. In this manner, when a relationship represented as l₁>f₁ₐ+f_{1b} is satisfied, the light transmitted through the convex lens 25b is converging light, and hence the information light is converged on the front side apart from the reflecting surface of the recording medium 6 as in Example 1. In this case, when the same calculation as that described with reference to equations (2) to (4) is carried out, rᵢₙ=−1.02×r₀, rₒᵤₜ=1.11×r₀, d₀=84 μm and r_{det}=−0.09×r₀ can be achieved. Note that, for imaging the first reproduced image on the image sensor 4, a distance from the spatial light modulator 23 to the convex lens 25 is set equal to l₄.

When recording, the recording medium 6 was rotated at a linear velocity of 0.1 m/s, and information was written by stopping rotation of the recording medium 6 when a center of the recessed portion 65a of the groove 65 was positioned on the optical axis of the objective lens 28. At this time, the recording reference light reflected by the reflecting layer 63 and transmitted through the beam splitter 29 was detected by a non-illustrated photodetector, and focusing, tracking and a write timing control were carried out by using the same method as that of the DVD.

When reproducing, the recording medium 6 was rotated at a linear velocity of 0.1 m/s. Focusing, tracking and a read timing control were carried out by the method described with reference to FIGS. 18 and 19. Under such conditions, outputs from first pixels 41a positioned in the area A4 were read, and information was reproduced from these outputs. As a result, S/N in reproduction was 3.8 dB.

### COMPARATIVE EXAMPLE

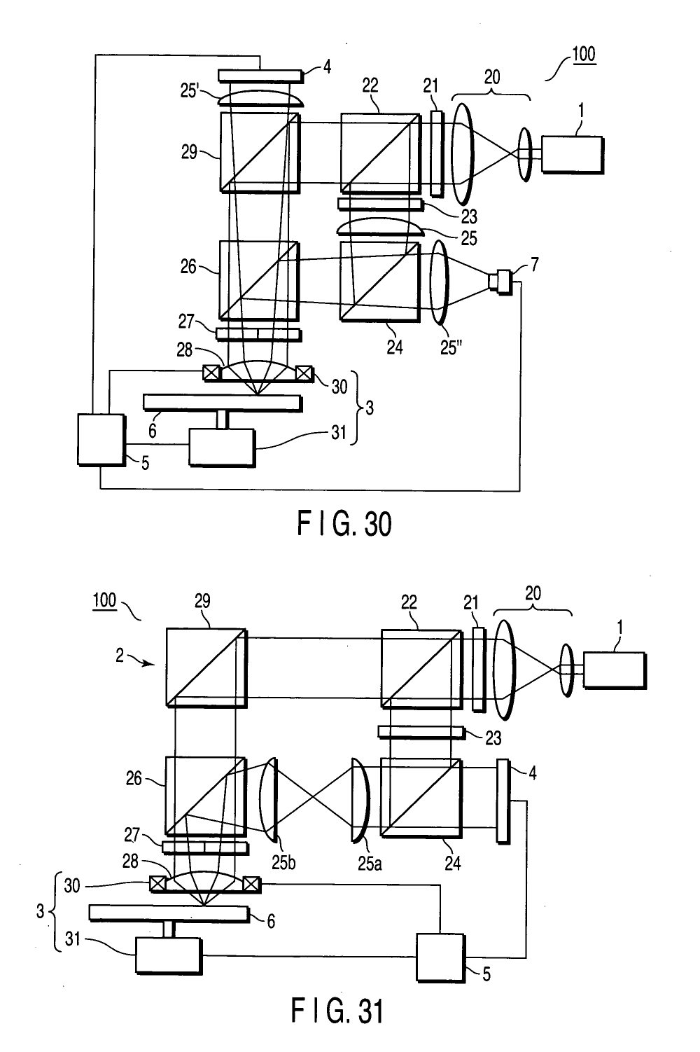

FIG. 30 is a view schematically showing a recording and reproducing apparatus according to a comparative example.

The recording and reproducing apparatus 100 has the same structure as that of the recording and reproducing apparatus 100 shown in FIG. 27 except that the following structure is employed.

That is, in the recording and reproducing apparatus shown in FIG. 30, the structure shown in FIG. 11 is employed in the image sensor 4, and the image sensor 4 is arranged above the beam splitter 29. The converging lens 25′ is arranged between the image sensor 4 and the beam splitter 29. A λ/2 retardation plate is used for each of the right portion and the left portion of the split retardation element 27. An optic axis of each of these λ/2 retardation plates forms an angle of ±45° with respect to a boundary between these λ/2 retardation plates. Furthermore, a converging lens 25″ and a four-split photodetector 7 are arranged on the right side of the beam splitter 24. The four-part photodetector 7 is connected with the information processor 5. It is to be noted that the optical system 2 is designed such that the recording reference light and the reproducing reference light are focused on the reflecting layer 6 and the information light is focused on a position spaced apart from the reflecting layer 6 on the front side of the reflecting layer 6.

In the recording and reproducing apparatus 100, the S-polarized light component which has entered the right portion of the split retardation element 27 is converted into linearly polarized light by rotating a polarization plane +45° (which will be referred to as an A-polarized light component hereinafter), and the S-polarized light component which has entered the left portion of the same is converted into linearly polarized light by rotating the polarization plane −45° (which will be referred to as a B-polarized light component hereinafter). In contrast, the P-polarized light component which has entered the right portion of the split retardation element 27 is converted into the B-polarized light component, and the P-polarized light component which has entered the left portion of the same is converted into the A-polarized light component. Furthermore, the A-polarized light component and the B-polarized light component which have entered the right portion of the split retardation element 27 are respectively converted into the S-polarized light component and the P-polarized light component, and the A-polarized light component and the B-polarized light component which have entered the left portion are respectively converted into the P-polarized light component an the S-polarized light component.

Therefore, in the recording and reproducing apparatus shown in FIG. 30, the recording reference light reflected by the reflecting layer 63 becomes the S-polarized light component when transmitted through the split retardation element 27, and is reflected by the polarizing beam splitter 26. In recording, the reflected light is detected by the four-split photodetector 7, and the information processor performs focusing, tracking and a write timing control based on various kinds of signals obtained by the detection.

Likewise, the reproducing reference light reflected by the reflecting layer 63 becomes the S-polarized light component when transmitted through the split retardation element 27, and is reflected by the polarizing beam splitter 26. In reproduction, the reflected light is detected by the four-split photodetector 7, and the information processor 5 performs focusing, tracking and a read timing control based on various kinds of signals obtained by the detection.

In the recording and reproducing apparatus 100 shown in FIG. 30, the phase conjugate reproduced light and the ordinary reproduced light produced by the reproducing reference light which has entered the right portion of the split retardation element 27 become the P-polarized light components when transmitted through the split retardation element 27, and are transmitted through the polarizing beam splitter 26. The phase conjugate reproduced light and the ordinary reproduced light transmitted through the polarizing beam splitter 26 respectively form the first reproduced image and the second reproduced image on the sensing surface of the image sensor 4. The information processor 5 reproduces information from outputs of all the pixels 41 positioned in an area corresponding to the first reproduced image, i.e., the area A1 shown in FIG. 11.

In this example, the recording medium 6 which was the same as that manufactured in Example 1 was mounted in the recording and reproducing apparatus 100 shown in FIG. 30, and recording of information and reproduction of the recorded information were carried out. In this example, as the light source 1 and the spatial light modulator 23, the members equal to those used in Examples 1 and 2 were utilized. Additionally, in this example, it is determined that d₁=90 mm, d₂=f₂, d₃=90 mm, f₁=100 mm and f₂=2 mm. In this case, rᵢₙ=0.1×r₀, rₒᵤₜ=−0.14×r₀, d₀=333 μm, and r_{det}=0.9×r₀.

In the recording and reproducing apparatus 100, recording and reproduction of information were performed under the same conditions as those in Example 1. As a result, S/N in reproduction was 1.0 dB, which was inferior to those in Examples 1 and 2.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. A reproducing apparatus which reproduces information recorded on a holographic recording medium comprising a reflecting layer with a reflecting surface and a recording layer facing the reflecting surface, comprising:
a light source which emits a light;
an image sensor with a sensing surface;
an optical system which focuses the light emitted from the light source as a reproducing reference light on the reflecting surface to produce a phase conjugate reproduced light and an ordinary reproduced light and guides the phase conjugate reproduced light and the ordinary reproduced light from the recording medium to the sensing surface to produce first and second images on the sensing surface, the first image corresponding to the phase conjugate reproduced light and the second image corresponding to the ordinary reproduced light, wherein the second image is smaller than the first image, and wherein an intensity of the ordinary reproduced light on the sensing surface is higher than an intensity of the phase conjugate reproduced light on the sensing surface; and
an information reproduction processor which processes an output of the image sensor corresponding to a non-overlapping portion to reproduce the information, the non-overlapping portion being a portion of the first image which does not overlap the second image.

2. The apparatus according to claim 1, wherein the information is recorded by a simultaneous irradiation of a recording reference light focused on the reflecting surface and an information light focused on a position spaced apart from the reflecting layer on the recording layer's side of the reflecting layer.

3. The apparatus according to claim 1, wherein the information reproduction processor obtains the output corresponding to the non-overlapping portion by using the second image as a timing signal.

4. The apparatus according to claim 1, wherein the optical system comprises an objective lens which faces the recording layer and focuses the reproducing reference light on the reflecting surface,
wherein the apparatus further comprises a drive mechanism which relatively moves the objective lens and the recording medium in first to third directions, the first direction being parallel to a recording track of the recording medium, the second direction being parallel to a main surface of the recording medium and crossing the first direction, and the third direction crossing the main surface, and wher
ein the information reproduction processor utilizes an output of the image sensor which corresponds to the second image for controlling at least one of first to third operations of the drive mechanism corresponding to the relative motions of the objective lens and the recording medium in the first to third directions, respectively.

5. The apparatus according to claim 4, wherein the information reproduction processor utilizes the second image as a timing signal to control the first operation of the drive mechanism.

6. The apparatus according to claim 4, wherein the information reproduction processor utilizes the second image as a position error signal to control the second operation of the drive mechanism.

7. The apparatus according to claim 4, wherein the first image includes a band like shade portion which extends across a center of the first image, and
wherein the information reproduction processor utilizes the band like shade portion as a position error signal to control the second operation of the drive mechanism.

8. The apparatus according to claim 4, wherein the information reproduction processor utilizes the second image as a focus error signal to control the third operation of the drive mechanism.

9. A recording and reproducing apparatus which records information on a holographic recording medium and reproduces the information recorded on the recording medium, the recording medium comprising a reflecting layer with a reflecting surface and a recording layer facing the reflecting surface, comprising:
a light source which emits a light;
an image sensor with a sensing surface;
an optical system which executes a first optical operation when information is recorded and executes a second optical operation when the information is reproduced, wherein the first optical operation includes focusing a part of the light emitted from the
light source as a recording reference light on the reflecting surface, producing an information light by generating a two dimensional distribution of optical property which corresponds to the information to be recorded in another part of the light emitted from the light source, and focusing the information light on a position spaced apart from the reflecting layer on the recording layer's side of the reflecting layer, and wherein the second optical operation includes focusing a part of the light emitted from the light source as a reproducing reference light on the reflecting surface to produce a phase conjugate reproduced light and an ordinary reproduced light and guiding the phase conjugate reproduced light and the ordinary reproduced light from the recording medium to the sensing surface to produce first and second images on the sensing surface, the first image corresponding to the phase conjugate reproduced light and the second image corresponding to the ordinary reproduced light, the second image being smaller than the first image, and an intensity of the ordinary reproduced light on the sensing surface being higher than an intensity of the phase conjugate reproduced light on the sensing surface; and
an information reproduction processor which processes an output of the image sensor corresponding to a non-overlapping portion to reproduce the information, the non-overlapping portion being a portion of the first image which does not overlap the second image.

10. The apparatus according to claim 9, wherein the optical system comprises:
a first polarizing beam splitter which splits the light emitted from the light source into first and second linearly polarized lights whose electric field vectors oscillate perpendicularly to each other;
a spatial light modulator which generates the two dimensional distribution of optical property in the second linearly polarized light to produce the information light;
a second polarizing beam splitter with first to third surfaces, the first surface being a surface through which the first linearly polarized light enters the second polarizing beam splitter as the recording reference light and the reproducing reference light, the second surface being a surface through which the information light enters the second polarizing beam splitter and through which the phase conjugate reproduced light and the ordinary reproduced light exit the second polarizing beam splitter, and the third surface being a surface through which the recording reference light, the reproducing reference light and the information light exit the second polarizing beam splitter and through which the phase conjugate reproduced light and the ordinary reproduced light enter the second polarizing beam splitter;
a converging lens disposed between the spatial light modulator and the second surface;
a split retardation element including first and second portions, wherein the first portion converts the recording reference light and the reproducing reference light which exit the second polarizing beam splitter into right-handed circularly polarized light and converts the information light which exits the second polarizing beam splitter into left-handed circularly polarized light, and wherein the second portion converts the recording reference light and the reproducing reference light which exit the second polarizing beam splitter into left-handed circularly polarized light and converts the information light which exit the second polarizing beam splitter into right-handed circularly polarized light; and
an objective lens disposed between the split retardation element and the recording medium.

11. The apparatus according to claim 10, further comprising a beam splitter with fourth to sixth surfaces, the fourth surface being a surface through which the information light from the spatial light modulator enters the beam splitter, the fifth surface being a surface through which the information light exits the beam splitter toward the second surface and through which the phase conjugate reproduced light and the ordinary reproduced light from the second surface enter the beam splitter, and the fifth surface being a surface through which the phase conjugate reproduced light and the ordinary reproduced light exit the beam splitter toward the sensing surface, wherein the converging lens is disposed between the second and fifth surfaces.

12. The apparatus according to claim 9, wherein the information reproduction processor obtains the output corresponding to the non-overlapping portion by using the second image as a timing signal.

13. The apparatus according to claim 9, wherein the optical system comprises an objective lens which faces the recording layer and focuses the reproducing reference light on the reflecting surface, wherein the apparatus further comprises a drive mechanism which relatively moves the objective lens and the recording medium in first to third directions, the first direction being parallel to a recording track of the recording medium, the second direction being parallel to a main surface of the recording medium and crossing the first direction, and the third direction crossing the main surface, and
wherein the information reproduction processor utilizes an output of the image sensor which corresponds to the second image for controlling at least one of first to third operations of the drive mechanism corresponding to the relative motions of the objective lens and the recording medium in first to third directions.

14. The apparatus according to claim 13, wherein the information reproduction processor utilizes the second image as a timing signal to control the first operation of the drive mechanism.

15. The apparatus according to claim 13, wherein the information reproduction processor utilizes the second image as a position error signal to control the second operation of the drive mechanism.

16. The apparatus according to claim 13, wherein the first image includes a band like shade portion which extends across a center of the first image, and
wherein the information reproduction processor utilizes the band like shade portion as a position error signal to control the second operation of the drive mechanism.

17. The apparatus according to claim 13, wherein the information reproduction processor utilizes the second image as a focus error signal to control the third operation of the drive mechanism.

18. A method of reproducing information recorded on a holographic recording medium comprising a reflecting layer with a reflecting surface and a recording layer facing the reflecting layer, the information being recorded by a simultaneous irradiation of a recording reference light focused on the reflecting surface and an information light focused on a position spaced apart from the reflecting layer on the recording layer's side of the reflecting layer, comprising:
focusing a light emitted from a light source as a reproducing reference light on the reflecting surface to produce a phase conjugate reproduced light and an ordinary reproduced light and guiding the phase conjugate reproduced light and the ordinary reproduced light from the recording medium to a sensing surface of an image sensor to produce first and second images on the sensing surface, the first image corresponding to the phase conjugate reproduced light and the second image corresponding to the ordinary reproduced light, wherein the second image is smaller than the first image, and wherein an intensity of the ordinary reproduced light on the sensing surface is higher than an intensity of the phase conjugate reproduced light on the sensing surface; and
processing an output of the image sensor corresponding to a non-overlapping portion to reproduce the information, the non-overlapping portion being a portion of the first image which does not overlap the second image.
